(19) United States
(12) Patent Application Publication
(10) Pub. No.: US 2019/0106579 A1
(43) Pub. Date: Apr. 11, 2019

(54) IONIC LIQUIDS FOR ANTI-ICING APPLICATIONS

(71) Applicant: PPG Industries Ohio, Inc., Cleveland, OH (US)

(72) Inventors: Steven E. Bowles, Pittsburgh, PA (US); Hongying Zhou, Allison Park, PA (US); Shanti Swarup, Allison Park, PA (US); Bruce A. Connelly, Gibsonia, PA (US); Emily Chunderlik, Seven Fields, PA (US); Justin M. Jones, Cranberry Township, PA (US)

(21) Appl. No.: 15/728,525

(22) Filed: Oct. 10, 2017

(51) Int. Cl. C09D 7/12; C09D 175/04; C09D 183/04

(52) U.S. Cl. CPC C09D 7/1233; C09D 175/04; C08K 9/06; C09D 183/04; C09D 7/125

(57) ABSTRACT

The present invention is directed to ionic liquids for use in a coating composition, the coating composition comprising an ionic liquid comprising a salt group and a first functional group, a film-forming polymer comprising a second functional group, and a curing agent comprising a third functional group, wherein the first functional group is reactive towards at least one of the second functional group and the third functional group.

### FIELD OF THE INVENTION

The present invention is directed towards coatings and coating compositions comprising ionic liquids for anti-icing applications.

### BACKGROUND INFORMATION

Ice control is a significant and practical concern for many industries. The everyday build-up of ice upon the surfaces of mechanical, physical, and natural objects is a familiar annoyance, and quite often a safety hazard. The slick layers of ice that form on highways, driveways, and walkways make transportation difficult. The masses of ice that accumulate within or upon industrial, agricultural, or other mechanical equipment make operation of the equipment difficult or impossible. The build-up of ice upon the wings and components of an aircraft is of particular concern. For example, icing on aircraft contributed to about 12% of the total accidents that occurred between 1990 and 2000, according to the AOPA Air Safety Foundation accident database.

Icing is most likely to occur when the outside temperature is between 0° C. to −20° C. Icing can cause the formation of ice on airfoils and other surfaces of the aircraft structure, including wings, stabilizers, rudder, ailerons, engine inlets, propellers, rotors, fuselage and the like. Ice on the aircraft surface can distort the flow of air over the wing, rapidly reducing the wing's lift and significantly increasing drag. Wind tunnel and flight tests have shown that frost, snow, and ice accumulations (on the leading edge or upper surface of the wing) no thicker or rougher than a piece of coarse sandpaper can reduce lift by 30 percent and increase drag up to 40 percent. Larger accretions can reduce lift even more and can increase drag by 80 percent or more.

Spraying aircraft on the ground with glycol-based fluids is expensive and detrimental to environment. For example, cleaning a Cessna 172 of ice or light snow might require 10-15 gallons of fluid for a total cost of up to $160; removing light frost on a clear day from a medium-sized business jet might cost $300, and removing freezing rain or a heavy wet snow from the same mid-sized jet may cost close to $10,000.

Chemicals such as derivatives of glycol ethers have also been used to de-ice aircrafts, as they effectively lower the freezing point. Recently, however, Canada has banned 2-methoxyethanol as a de-icing chemical because of environmental concerns.

Anti-icing and de-icing are the two basic approaches to prevent icing for aircraft. Anti-Icing is turned on before the flight enters icing conditions, while de-icing is used after ice has built up. There are several types of de-ice and/or anti-ice systems for modern aircraft that are generally categorized as mechanical, chemical and thermal. Specific examples include pneumatic boots, multiple juxtaposed electro-expulsive elements, de-icing fluids, diverted bleed air or hot air from turbine stages, and electrically conducting resistance heating elements. Energy consumption for this equipment is large. For example, the wattage required for an anti-ice system in a typical high-performance single engine or light twin aircraft, using the resistance heaters, is approximately 21,000 watts.

Polyurethane coatings are currently applied onto all aircraft exterior surfaces due to the high performance such as durability, weather resistance, chemical resistance, low temperature resistance, corrosion resistance and fluid resistance. However, the polyurethane chemical structure has high surface energy and strong adhesion to the ice believed to be due to hydrogen bonding.

It would be desirable to provide a coating composition that upon cure significantly reduces the ice adhesion to a substrate coated with the same. It would also be desirable to provide a method of mitigating ice build-up on a substrate using a coating that can significantly reduce the ice adhesion and meet the aircraft coatings material specification requirement.

### SUMMARY OF THE INVENTION

The present invention is directed to a coating composition comprising an ionic liquid comprising a salt group and a first functional group; a film-forming polymer comprising a second functional group; and a curing agent comprising a third functional group; wherein the first functional group is reactive towards at least one of the second functional group and the third functional group.

The present invention is also directed to a coating composition comprising an ionic liquid comprising a salt group and a first functional group; and a self-curing film-forming polymer comprising a second functional group; wherein the first functional group is reactive towards the second functional group.

The present invention is further directed to a method of reducing ice adhesion to a substrate surface comprising applying the coating composition of the present invention to the surface of the substrate and at least partially curing the coating composition to form a coating.

The present invention is also directed to a coating formed by coating composition of the present invention in an at least partially cured state.

The present invention is further directed to a substrate coated with the coating composition of the present invention in an at least partially cured state.

### DETAILED DESCRIPTION OF THE INVENTION

The present invention is directed to ionic liquids for use in a coating composition, and coating compositions comprising, consisting of, or consisting essentially of an ionic liquid comprising a salt group and a first functional group, a film-forming polymer comprising a second functional group, and a curing agent comprising a third functional group, wherein the first functional group is reactive towards at least one of the second functional group and the third functional group.

According to the present invention, the coating composition comprises an ionic liquid. Ionic liquids are salts that are liquid (i.e., melted) at temperatures less than or equal to 400° C., such as at temperatures less than 100° C., such as at temperatures less than or equal to 75° C., such as at temperatures less than or equal to room temperature (i.e., 25° C.). Accordingly, the ionic liquid comprises a salt group comprising a cation and an anion. Suitable cations may comprise, for example, imidazolium; pyridinium; pyrrolidinium; phosphonium; ammonium; guanidinium; isouronium; thiouronium; and sulphonium groups. Suitable anions may comprise, for example, a halogen anion (i.e., halide) such as fluoride, chloride, bromide and iodide; tetrafluoroborate; hexafluorophosphate; bis(trifluoromethylsulfonyl)imide; tris(pentafluoroethyl)trifluorophosphate (FAPs); trifluoromethanesulfonate; trifluoroacetate; methylsulfate; octylsulfate; thiocyanate; organoborate; and p-toluenesulfonate. The salt group may comprise any combination of the above cation(s) and anion(s), and other suitable cations or anions not listed may be used.

The ionic liquid may further comprise a first functional group. The functional group may comprise, for example, a hydroxyl group or an alkoxy silyl group. The presence of the first functional group allows for the ionic liquid to be capable of reacting with other components of the coating composition through chemical reaction with the first functional group. For example, incorporation of a hydroxyl functional group may allow the ionic liquid to react with compounds having a functional group that is reactive with hydroxyl, such as, for example, a compound having an isocyanato group. According to the present invention, the ionic liquid may comprise two or more of the first functional group, and the two or more first functional groups may be the same or different functional groups.

The ionic liquid may further comprise a divalent organic radical that covalently bonds the salt group with the first functional group. The divalent organic radical may comprise a substituted or unsubstituted, branched or unbranched alkanediyl group, or a substituted or unsubstituted, branched or unbranched C₆-C₃₆ aromatic group. The substitution of the alkyl group or benzyl ring, if any, may comprise, for example, urethane, urea, ether or thioether functional groups, as well as combinations thereof.

The ionic liquid may comprise a monomeric compound having one salt group per molecule, and may be referred to as a monomeric ionic liquid.

The ionic liquid may comprise a compound having at least two salt groups per molecule, including polymeric compounds, and may be referred to as a polymeric ionic liquid.

Non-limiting examples of the ionic liquids of the present invention may be represented by the following Formulas (I) to (IV). According to Formula (I) of the present invention, the ionic liquid may comprise a monomeric compound and may comprise or represent:

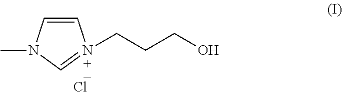

According to Formula (II) of the present invention, the ionic liquid may comprise a monomeric compound and may comprise or represent:

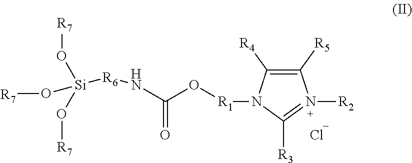

wherein R₁ is a substituted or unsubstituted C₁-C₃₆ alkanediyl group or a substituted or unsubstituted C₆-C₃₆ divalent aromatic group; R₂ is hydrogen, a substituted or unsubstituted C₁-C₃₆ alkyl group or a substituted or unsubstituted C₆-C₃₆ aromatic group; R₃ is hydrogen or a substituted or unsubstituted C₁-C₃₆ alkyl group; R₄ is hydrogen or a substituted or unsubstituted C₁-C₃₆ alkyl group; R₅ is hydrogen or a substituted or unsubstituted C₁-C₃₆ alkyl group; R₆ is a C₁ to C₃₆ alkanediyl group, a linear or branched C₃ to C₃₆ cycloaliphatic group, or a linear or branched C₆ to C₃₆ aromatic group; and R₇ is each independently a substituted or unsubstituted C₁-C₄ alkyl group.

Suitable ionic liquids according to Formula (II) include the monomeric compound represented by Formula (III):

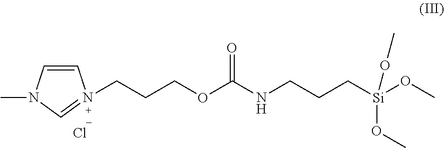

The ionic liquid when in the form of a monomeric compound may be present in the coating composition in an amount of at least 0.5% by weight, based on the total weight of the resin solids, such as at least 2% by weight, such as at least 4% by weight, and may be present in an amount of no more than 25% by weight, based on the total weight of the resin solids, such as no more than 17% by weight, such as no more than 14% by weight. According to the present invention, the ionic liquid when in the form of a monomeric compound may be present in the coating composition in an amount of 0.5% to 25% by weight, based on the total weight of the resin solids, such as 2% to 17% by weight, such as 4% to 14% by weight.

According to Formula (IV) of the present invention, the ionic liquid may comprise a monomeric (when n=1) or a polymeric compound and may comprise or represent:

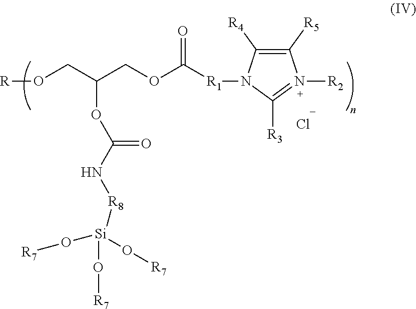

wherein n≥1, such as 1 to 6; R is a monovalent or polyvalent, substituted or unsubstituted C₁-C₃₆ alkane group, a monovalent or polyvalent C₆-C₃₆ aromatic group, a monovalent or polyvalent C₃-C₃₆ cycloaliphatic group, a monovalent or polyvalent polyester group having a number average molecular weight (Mₙ) of greater than 200 g/mol, a monovalent or polyvalent polyether group having a number average molecular weight (Mₙ) of greater than 200 g/mol, a monovalent or polyvalent acrylic resin having a number average molecular weight (Mₙ) of greater than 500 g/mol, or a monovalent or polyvalent polyurethane group having a number average molecular weight (Mₙ) of greater than 500 g/mol; R₁ is a substituted or unsubstituted C₁-C₃₆ alkanediyl group or a substituted or unsubstituted C₆-C₃₆ aromatic group; R₂ is hydrogen, a substituted or unsubstituted C₁-C₃₆ alkyl group, or a substituted or unsubstituted C₆-C₃₆ aromatic group; R₃ is hydrogen or a substituted or unsubstituted C₁-C₃₆ alkyl group; R₄ is hydrogen or a substituted or unsubstituted C₁-C₃₆ alkyl group; R₅ is hydrogen or a substituted or unsubstituted C₁-C₃₆ alkyl group; R₆ is a C₁ to C₃₆ alkanediyl group, a linear or branched C₃ to C₃₆ cycloaliphatic group, or a linear or branched C₆ to C₃₆ aromatic group; and R₇ is each independently a substituted or unsubstituted C₁-C₄ alkyl group.

The number average molecular weight (Mₙ) and weight average molecular weight (M_{w}) may be determined by any technique known in the art such as, for example, Gel Permeation Chromatography using Waters 2695 separation module with a Waters 410 differential refractometer (RI detector), polystyrene standards having molecular weights of from approximately 500 g/mol to 900,000 g/mol, tetrahydrofuran (THF) with lithium bromide (LiBr) as the eluent at a flow rate of 0.5 mL/min, and one Asahipak GF-510 HQ column for separation.

The ionic liquid when in the form of a polymeric compound may be present in the coating composition in an amount of at least 0.5% by weight, based on the total weight of the resin solids, such as at least 10% by weight, such as at least 20% by weight, and may be present in an amount of no more than 50% by weight, based on the total weight of the resin solids, such as no more than 40% by weight, such as no more than 35% by weight. According to the present invention, the ionic liquid when in the form of a polymeric compound may be present in the coating composition in an amount of 0.5% to 50% by weight, based on the total weight of the resin solids, such as 10% to 40% by weight, such as 20% to 35% by weight.

The ionic liquid, when in the form of a monomeric or polymeric compound, may be present in the coating composition in an amount such that the equivalents of salt groups in the resulting coating composition is at least 0.001 equivalents of salt per gram of resin solids, such as at least 0.010, such as at least 0.014, such as at least 0.020. The ionic liquid, when in the form of a monomeric or polymeric compound, may be present in the coating composition in an amount such that the equivalents of salt groups in the resulting coating composition is 0.001 to 0.300 equivalents of salt per gram of resin solids, such as 0.010 to 0.250, such as 0.014 to 0.200, such as 0.014 to 0.150.

The ionic liquid may be substantially free, essentially free, or completely free of alkali metals and alkaline earth metals. As used herein, “alkali metals” refers to the elements other than hydrogen included in Group I of the periodic table of the elements including lithium (Li), sodium (Na), potassium (K), rubidium (Rb), cesium (Cs), and francium (Fr). As used herein, “alkaline earth metals” refers to the elements included in Group II of the periodic table of the elements including beryllium (Be), magnesium (Mg), calcium (Ca), strontium (Sr), barium (Ba), and radium (Ra). As used herein, an ionic liquid is “substantially free” of alkali metals and alkaline earth metals if alkali metals and alkaline earth metals are present in the ionic liquid in an amount of less than 5% by weight, based on the total weight of the salt group of the ionic liquid. As used herein, an ionic liquid is “essentially free” of alkali metals and alkaline earth metals if alkali metals and alkaline earth metals are present in the ionic liquid in an amount of less than 1% by weight, based on the total weight of the salt group of the ionic liquid. As used herein, an ionic liquid is “completely free” of alkali metals and alkaline earth metals if alkali metals and alkaline earth metals are not present in the ionic liquid, i.e., 0%.

According to the present invention, the coating composition may comprise a film-forming polymer. As used herein, the term “polymer” is meant to encompass oligomers, and includes, without limitation, both homopolymers and copolymers. The film-forming polymer may be selected from, for example, polyol polymers, acrylic polymers, polyester polymers, alkyd polymers, polyurethane polymers, polyamide polymers, polyether polymers, epoxy polymers, polysiloxane polymers, copolymers thereof, and mixtures thereof. Generally, these polymers may be any polymers of these types made by any method known to those skilled in the art. Such polymers may be solvent-borne or water-dispersible, emulsifiable, or of limited water solubility. Appropriate mixtures of film-forming polymers may also be used in the preparation of the present compositions.

The film-forming polymer may comprise a “second” functional group. The term “second” functional group is meant to distinguish the functional group of the film-forming polymer from a functional group of any other component of the coating composition, such as, for example, the first functional group of the ionic liquid, and has no other meaning. For example, the term “second” functional group is not meant to refer to a functional group in addition to a different functional group present on the film-forming polymer. As such, the film-forming polymer may comprise one or more of the “second” functional group without any other functional group being present on the film-forming polymer. According to the present invention, the film-forming polymer may be di-functional, tri-functional, or poly-functional, wherein the film-forming polymer comprises at least 2, at least 3, or more of the second functional group. The second functional group on the film-forming resin may comprise any of a variety of reactive functional groups including, for example, a hydroxyl functional group, epoxy functional group, mercaptan functional group, siloxane functional group, amino functional group, or combinations thereof.

The polyol polymer may comprise any suitable polyhydroxyl-functional polymer known in the art. Nonlimiting examples include polyester polyols, polyether polyols, polyurethane polyols, alkyd polyols, and acrylic polyols. Appropriate mixtures of these polymers may be used as well. Some examples of polyol polymers are described in more detail below.

The acrylic polymer may comprise any suitable acrylic polymer known in the art. Suitable acrylic polymers include addition polymers of one or more ethylenically unsaturated monomers such as alkyl esters of acrylic acid or methacrylic acid, optionally together with one or more other polymerizable ethylenically unsaturated monomers. Useful alkyl esters of acrylic acid or methacrylic acid include aliphatic alkyl esters containing from 1 to 30, such as 4 to 18 carbon atoms in the alkyl group. Non-limiting examples include methyl methacrylate, ethyl methacrylate, butyl methacrylate, ethyl acrylate, butyl acrylate, and 2-ethyl hexyl acrylate. Suitable other copolymerizable ethylenically unsaturated monomers include vinyl aromatic compounds such as styrene and vinyl toluene; nitriles such as acrylonitrile and methacrylonitrile; vinyl and vinylidene halides such as vinyl chloride and vinylidene fluoride and vinyl esters such as vinyl acetate.

The acrylic polymer may include hydroxyl functional groups, which may be incorporated into the polymer by including one or more hydroxyl functional monomers in the reactants used to produce the polymer. Useful hydroxyl functional monomers include hydroxyalkyl acrylates and methacrylates, typically having 2 to 4 carbon atoms in the hydroxyalkyl group, such as hydroxyethyl acrylate, hydroxypropyl acrylate, 4-hydroxybutyl acrylate, hydroxyl functional adducts of caprolactone and hydroxyalkyl acrylates, and corresponding methacrylates, as well as the beta-hydroxy ester functional monomers described below.

Beta-hydroxy ester functional monomers can be prepared from ethylenically unsaturated, epoxy functional monomers and carboxylic acids having from about 2 to about 20 carbon atoms, or from ethylenically unsaturated acid functional monomers and epoxy compounds comprising at least 5 carbon atoms which are not polymerizable with the ethylenically unsaturated acid functional monomer.

Useful ethylenically unsaturated, epoxy functional monomers used to prepare the beta-hydroxy ester functional monomers include, but are not limited to, glycidyl acrylate, glycidyl methacrylate, allyl glycidyl ether, methallyl glycidyl ether, 1:1 (molar) adducts of ethylenically unsaturated monoisocyanates with hydroxy functional monoepoxides such as glycidol, and glycidyl esters of polymerizable polycarboxylic acids such as maleic acid. Examples of carboxylic acids include, but are not limited to, saturated monocarboxylic acids such as isostearic acid and aromatic unsaturated carboxylic acids.

Useful ethylenically unsaturated acid functional monomers used to prepare the beta-hydroxy ester functional monomers include monocarboxylic acids such as acrylic acid, methacrylic acid, crotonic acid; dicarboxylic acids such as itaconic acid, maleic acid and fumaric acid; and monoesters of dicarboxylic acids such as monobutyl maleate and monobutyl itaconate. The ethylenically unsaturated acid functional monomer and epoxy compound are typically reacted in a 1:1 equivalent ratio. The epoxy compound does not contain ethylenic unsaturation that would participate in free radical-initiated polymerization with the unsaturated acid functional monomer. Useful epoxy compounds include 1,2-pentene oxide, styrene oxide and glycidyl esters or ethers, containing from 8 to 30 carbon atoms, such as butyl glycidyl ether, octyl glycidyl ether, phenyl glycidyl ether and para-(tertiary butyl) phenyl glycidyl ether. Suitable glycidyl esters of carboxylic acids include VERSATIC ACID 911 and CARDURA E, each of which is commercially available from Shell Chemical Co.

The polyester polymer may comprise any suitable polyester polymer known in the art. Such polyester polymers may be prepared by condensation of polyhydric alcohols and polycarboxylic acids. Suitable polyhydric alcohols include, but are not limited to, ethylene glycol, propylene glycol, butylene glycol, 1,6-hexylene glycol, neopentyl glycol, diethylene glycol, glycerol, trimethylol propane, and pentaerythritol. Suitable polycarboxylic acids include, but are not limited to, succinic acid, adipic acid, azelaic acid, sebacic acid, maleic acid, fumaric acid, phthalic acid, tetrahydrophthalic acid, hexahydrophthalic acid, and trimellitic acid. Besides the polycarboxylic acids mentioned above, functional equivalents of the acids such as anhydrides where they exist or lower alkyl esters of the acids such as the methyl esters may be used. Polyesters derived from cyclic esters such as caprolactone may also be suitable. The polyester polymer may be linear or branched and may comprise hydroxyl, carboxyl, anhydride, epoxy and/or carbamate functional groups.

The polyester polymer may comprise hydroxyl functional groups. For example, the polyester polymer may be prepared by selecting reactants having hydroxyl functional groups in excess compared to carboxylic acid functional group equivalents such that the resulting polyester polymer comprises hydroxyl functional groups and the desired molecular weight.

The polyester polymers may comprise epoxy functional groups prepared by art-recognized methods, which may include first preparing a hydroxyl functional polyester that is further reacted with epichlorohydrin.

The polyester polymer may comprise pendent and/or terminal carbamate functional groups prepared by first forming a hydroxyalkyl carbamate which can be reacted with the polycarboxylic acids and polyols used in forming the polyester. The hydroxyalkyl carbamate may be condensed with acid functionality on the polyester yielding carbamate functionality. Carbamate functional groups may also be incorporated into the polyester by reacting a hydroxyl functional polyester with a low molecular weight carbamate functional material via a transcarbamoylation process or by reacting isocyanic acid with a hydroxyl functional polyester.

Amide functionality may be introduced to the polyester polymer by using suitably functional reactants in the preparation of the polymer, or by converting other functional groups to amido-groups using techniques known to those skilled in the art. Likewise, other functional groups may be incorporated as desired using suitably functional reactants if available or conversion reactions as necessary.

The alkyd polymer may comprise any suitable alkyd polymer known in the art. The alkyd polymer may comprise the residue/reaction product of a polyester resin and an acid. The polyester resin may comprise the residue/reaction product of a diacid and/or acid anhydride and a polyol. The diacid may comprise phthalic acid, succinic acid, adipic acid, azelaic acid, sebacic acid, maleic acid, fumaric acid, tetrahydrophthalic acid, and hexahydrophthalic acid. Besides the diacids mentioned above, functional equivalents of the diacids such as anhydrides where they exist may be used, including, for example, phthalic anhydride and maleic anhydride. Combinations of the diacids and/or acid anyhydrides may also be used. The polyol may comprise ethylene glycol, propylene glycol, butylene glycol, 1,6-hexylene glycol, neopentyl glycol, diethylene glycol, glycerol, trimethylol propane, glycerol, pentaerythritol, and combinations thereof.

The acid may comprise an organic acid, such as a fatty acid. The fatty acid may comprise a C₄-C₃₆ organic acid. The fatty acid may comprise an unsaturated fatty acid. Suitable unsaturated fatty acids may include, but are not limited to, α-linolenic acid, stearidonic acid, eicosapentaenoic acid, linoleic acid, γ-linolenic acid, dihomo-γ-linolenic acid, arachidonic acid, palmitoleic acid, vaccenic acid, paullinic acid, oleic acid, elaidic acid, gondoic acid, crotonic acid, myristoleic, sapienic acid, eicosadienoic acid, pinolenic acid, eleostearic acid, and mead acid. The acid may also be derived from an oil. The oil may comprise a vegetable oil or tall oil. Suitable vegetable oils include, but at not limited to, soybean oil, linseed oil, palm oil, coconut oil, canola oil, and sunflower oil. Combinations of acids and/or oils may also be used.

The polyurethane polymer may comprise any suitable polyurethane polymer known in the art. Non-limiting examples of suitable polyurethane polymers having pendent and/or terminal hydroxyl functional groups are prepared by reacting polyols with polyisocyanate such that the OH/NCO (hydroxyl to isocyanate) equivalent ratio is greater than 1:1 such that free hydroxyl groups are present in the product. Alternatively, isocyanate functional polyurethanes may be prepared using similar reactants in relative amounts such that the OH/NCO equivalent ratio is less than 1:1. Such reactions employ typical conditions for urethane formation, for example, temperatures of 30° C. to 160° C. and up to ambient pressure, as known to those skilled in the art.

The organic polyisocyanates that may be used to prepare the polyurethane polymer include one or more aliphatic diisocyanates or higher polyisocyanates.

Examples of suitable aliphatic diisocyanates include straight chain aliphatic diisocyanates, such as 1,6-hexamethylene diisocyanate. Also, cycloaliphatic diisocyanates may be employed. Examples include isophorone diisocyanate and 4,4′-methylene-bis-(cyclohexyl isocyanate). Examples of suitable higher polyisocyanates include 1,2,4-benzene triisocyanate and polymethylene polyphenyl isocyanate.

Terminal and/or pendent carbamate functional groups may be incorporated into the polyurethane by reacting a polyisocyanate with a polyol containing the terminal/pendent carbamate groups. Alternatively, carbamate functional groups may be incorporated into the polyurethane by reacting a polyisocyanate with a polyol and a hydroxyalkyl carbamate or isocyanic acid as separate reactants. Carbamate functional groups may also be incorporated into the polyurethane by reacting a hydroxyl functional polyurethane with a low molecular weight carbamate functional material via a transcarbamoylation process. Additionally, an isocyanate functional polyurethane may be reacted with a hydroxyalkyl carbamate to yield a carbamate functional polyurethane.

Amide functionality may be introduced to the polyurethane polymer by using suitably functional reactants in the preparation of the polymer, or by converting other functional groups to amido-groups using techniques known to those skilled in the art. Likewise, other functional groups may be incorporated as desired using suitably functional reactants if available or conversion reactions as necessary.

The polyamide polymer may comprise any suitable polyamide polymer known in the art. Non-limiting examples of the polyamide polymer include the condensation products of polyamines and the oligomeric fatty acids. The polyamine may be diethylenetriamine, triethylenetetramine, tetraethylenepentamine and those generally illustrated by the formula H(HNR)ₙNH₂ where R is an alkanediyl having from 2 to 6 carbon atoms and n is an integer of 1 to 6. The oligomeric fatty acids may be those resulting from the polymerization of drying or semi-drying oils or their free acids, or the simple aliphatic alcohol esters of these acids, particularly from sources rich in linoleic acid. Simple drying or semi-drying oils include soybean, linseed, tung, perilla, cottonseed, corn, sunflower, safflower and dehydrated castor oils. Suitable fatty acids may also be obtained from tall oil, soap stock and other similar materials. In the process for the preparation of the oligomeric fatty acid, the fatty acids with sufficient double bond functionality combine for the most part probably by a Diels-Alder mechanism, to provide a mixture of dibasic and oligomeric fatty acids. These acids are referred to as dimers, trimers and the like. The term “oligomeric fatty acids” as used herein, is intended to include any individual oligomeric fatty acid as well as mixtures of oligomeric fatty acids, the latter usually containing a predominant portion of dimer acids, a small quantity of trimer and higher polymeric fatty acids and some residual monomer. The oligomeric fatty acids containing predominantly the dimeric form of the acid with some residual monomer and small quantities of trimer and higher polymeric fatty acid may be hydrogenated if desired and the hydrogenated product employed to form the polyamide. In addition, the oligomeric fatty acids may be distilled to provide relatively high dimer content acids.

The polyamine and the oligomeric fatty acid are condensed at elevated temperatures to form the polyamide. An excess of polyamine may be used to get an amine functional (such as amine terminated) polyamide in which the amine functional groups are in the terminal position of the polyamide. By excess is meant the ratio of equivalents of amine to equivalents of carboxyl is greater than 1. The reaction product may have an amine number in the range of 50 to 80, as measured by any suitable technique known in the art.

The polyamide may be combined with an epoxidized olefin. The epoxidized olefin and the polyamide are mixed and heated to a temperature of 100° C. to 225° C. to form a product. The weight ratio of polyamide to epoxidized olefin may be 10 to 40:90 to 60. Reaction time varies depending on the temperature but is typically from 30 minutes to 3 hours.

The polyether polymer may comprise any suitable polyether polymer known in the art. For example, the polyether polymer may comprise a polyether polyol formed from oxyalkylation of various polyols, for example, diols such as ethylene glycol, 1,6-hexanediol, Bisphenol A and the like, or other higher polyols such as trimethylolpropane, pentaerythritol, and the like. Polyols of higher functionality which can be utilized as indicated can be made, for instance, by oxyalkylation of compounds such as sucrose or sorbitol. One commonly utilized oxyalkylation method is reaction of a polyol with an alkylene oxide, for example, propylene or ethylene oxide, in the presence of an acidic or basic catalyst. Particular polyethers include those sold under the names TERATHANE and TERACOL, available from E. I. Du Pont de Nemours and Company, Inc., and POLYMEG, available from Q 0 Chemicals, Inc., a subsidiary of Great Lakes Chemical Corp.

The polyether polymer may also comprise a polyetheramine. A polyetheramine will be understood as referring to a compound having one or more amine functional groups attached to a polyether backbone such as one characterized by propylene oxide, ethylene oxide, or mixed propylene oxide and ethylene oxide repeating units in their respective structures, such as, for example, one of the Jeffamine series products. Examples of such polyetheramines include aminated propoxylated pentaerythritols, such as Jeffamine XTJ-616, and those represented by Formulas (V) through (VII).

According to Formula (V) the polyetheramine may comprise:

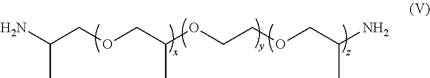

wherein y=0-39, x+z=1-68.

Suitable polyetheramines represented by Formula (V) include, but are not limited to, amine-terminated polyethylene glycol such as those commercially available from Huntsman Corporation in its JEFFAMINE ED series, such as JEFFAMINE HK-511, JEFFAMINE ED-600, JEFFAMINE ED-900 and JEFFAMINE ED-2003, and amine-terminated polypropylene glycol such as in its JEFFAMINE D series, such as JEFFAMINE D-230, JEFFAMINE D-400, JEFFAMINE D-2000 and JEFFAMINE D-4000.

According to Formula (VI) the polyetheramine may comprise:

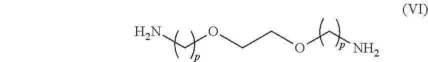

wherein each p independently is 2 or 3.

Suitable polyetheramines represented by Formula (VI) include, but are not limited to, amine-terminated polyethylene glycol based diamines, such as Huntsman Corporation's JEFFAMINE EDR series, such as JEFFAMINE EDR-148 and JEFFAMINE EDR-176.

According to Formula (VII) the polyetheramine may comprise:

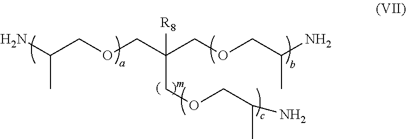

wherein R₈ is H or C₂H₅, m=0 or 1, a+b+c=5-85.

Suitable polyetheramines represented by Formula (VII) include, but are not limited to, amine-terminated propoxylated trimethylolpropane or glycerol, such as Huntsman Corporation's JEFFAMINE T series, such as JEFFAMINE T-403, JEFFAMINE T-3000 and JEFFAMINE T-5000.

The polysiloxane polymer may include any suitable polysiloxane polymer known in the art. The polysiloxane may have a weight average (M_{w}) molecular weight of 200 g/mol to 100,000 g/mol, such as 500 g/mol to 100,000 g/mol, such as 1,000 g/mol to 75,000 g/mol and such as 2,000 g/mol to 50,000 g/mol. Suitable polysiloxanes include polymeric polysiloxanes such as polydimethylsiloxane (PDMS). The polysiloxane may have at least one functional group that is reactive with functional groups on at least one other component in the coating composition, such as the ionic liquid or curing agent. For example, the polysiloxane may have at least one hydroxyl and/or amine functional group, such as PDMS with at least two amine functional groups, allowing it to react with a curing agent having isocyanate functional groups. Suitable polysiloxane polymers also include those manufactured as described in U.S. Pat. Nos. 5,275,645 and 5,618,860, incorporated by reference in their entirety, such as PSX 700, commercially available from PPG Industries. Examples of other commercially available polysiloxanes include WACKER FLUID NH 130D, from WACKER Chemie AG; Shin-Etsu KF-6003, available from Shin-Etsu; MCR-C18, MCR-C62, and DMS-531, available from GELEST, Inc.; and DC 200-1000, available from Dow Corning.

The epoxy polymer may comprise any suitable epoxy polymer known in the art. For example, the epoxy polymer may be prepared by reacting a polyepoxide and a polyol selected from alcoholic hydroxyl group-containing materials and phenolic hydroxyl group-containing materials to chain extend or build the molecular weight of the polyepoxide. The chain extended polyepoxide typically is prepared as follows: the polyepoxide and polyol are reacted together “neat” or in the presence of an inert organic solvent such as a ketone, including methyl isobutyl ketone and methyl amyl ketone, aromatics such as toluene and xylene, and glycol ethers such as the dimethyl ether of diethylene glycol. The reaction typically is conducted at a temperature of 80° C. to 160° C. for 30 to 180 minutes until an epoxy polymer reaction product is obtained. The equivalent ratio of reactants (i.e., epoxy:polyol) may range from 1.00:0.50 to 1.00:2.00. As will be appreciated by one of skill in the art, the epoxy polymer may comprise epoxy functional groups and/or hydroxyl functional groups depending upon the ratio of reactants.

The polyepoxide typically has at least two 1,2-epoxy groups. The polyepoxide may be saturated or unsaturated, cyclic or acyclic, aliphatic, alicyclic, aromatic or heterocyclic. Moreover, the polyepoxide may contain substituents such as halogen, hydroxyl, and ether groups. Examples of polyepoxides are those having a 1,2-epoxy equivalency greater than one and/or two; that is, polyepoxides which have on average at least two epoxide groups per molecule. Suitable polyepoxides include polyglycidyl ethers of polyhydric alcohols such as cyclic polyols and polyglycidyl ethers of polyhydric phenols such as Bisphenol A. These polyepoxides can be produced by etherification of polyhydric phenols with an epihalohydrin or dihalohydrin such as epichlorohydrin or dichlorohydrin in the presence of alkali. Besides polyhydric phenols, other cyclic polyols can be used in preparing the polyglycidyl ethers of cyclic polyols. Examples of other cyclic polyols include alicyclic polyols, particularly cycloaliphatic polyols such as hydrogenated bisphenol A, 1,2-cyclohexane diol and 1,2-bis(hydroxymethyl)cyclohexane. Epoxy group-containing acrylic polymers may also be used in the present invention.

Examples of polyols used to chain extend or increase the molecular weight of the polyepoxide (i.e., through hydroxyl-epoxy reaction) include alcoholic hydroxyl group-containing materials and phenolic hydroxyl group-containing materials. Examples of alcoholic hydroxyl group-containing materials are simple polyols such as neopentyl glycol; polyester polyols such as those described in U.S. Pat. No. 4,148,772; polyether polyols such as those described in U.S. Pat. No. 4,468,307; and urethane diols such as those described in U.S. Pat. No. 4,931,157. Examples of phenolic hydroxyl group-containing materials are polyhydric phenols such as Bisphenol A, phloroglucinol, catechol, and resorcinol. Mixtures of alcoholic hydroxyl group-containing materials and phenolic hydroxyl group-containing materials may also be used.

When used in combination with the monomeric ionic liquid, the film-forming polymer may be present in the coating composition in an amount of at least 20% by weight, based on the total weight of the resin solids, such as at least 40% such as at least 50% by weight, and may be present in an amount of no more than 90% by weight, such as no more than 85% by weight, such as no more than 77% by weight. The film-forming polymer may be present in the coating composition in an amount of 20% by weight to 90% by weight, based on the total weight of the resin solids, such as 40% by weight to 85% by weight, such as 50% by weight to 77% by weight.

It is also possible that the ionic liquid is itself included as part or all of the film-forming polymer. For example, the ionic liquid described above may be incorporated into a polymer to form a polymeric ionic liquid that serves as the film-forming polymer. Such film-forming polymer could react with an appropriately selected curing agent. The curing agent could be selected from any curing agent known in the art to crosslink with the functionality on the polymer. Suitable curing agents are more fully described below. Additionally, the film-forming polymer may also be self-curing and cure without requiring a curing agent. Accordingly, a further film-forming polymer is optional when used in combination with a polymeric ionic liquid.

When the ionic liquid is in the form of a polymeric ionic liquid, the film-forming polymer may be present in the coating composition in an amount of at least 0.5% by weight, based on the total weight of the resin solids, such as at least 10% such as at least 30% by weight, and may be present in an amount of no more than 80% by weight, such as no more than 70% by weight, such as no more than 65% by weight. The film-forming polymer may be present in the coating composition in an amount of 0.5% by weight to 80% by weight, based on the total weight of the resin solids, such as 10% by weight to 70% by weight, such as 30% by weight to 65% by weight.

According to the present invention, the coating composition may optionally comprise a curing agent. The curing agent may comprise any curing agent known in the art to crosslink with the functionality on the film-forming polymer. Accordingly, the curing agent comprises a third functional group that is reactive with the second functional group of the film-forming polymer. The term “third” functional group is meant to distinguish the functional group of the curing agent from a functional group of any other component of the coating composition, such as the first functional group of the ionic liquid or the second functional group of the film-forming polymer, and has no other meaning. For clarity, the term “third” functional group is not meant to refer to a functional group in addition to a different functional group(s) present on the curing agent. As such, the curing agent may comprise two or more of the “third” functional group with or without any other functional group being present on the curing agent. One skilled in the art can select an appropriate curing agent based on the functionality of the film-forming polymer from known curing agents such as, for example, melamine, phenolic, carbodiimide, hydroxyalkylamide, isocyanate, blocked isocyanate, benzoguanamine, epoxies, oxazolines, aminosilane, and the like. Accordingly, the third functional group may comprise amino, hydroxyl, isocyanato, epoxy, siloxane, or combinations thereof.

The curing agent may comprise one or more polyisocyanates such as diisocyanates, triisocyanates and higher functional isocyanates, and may comprise biurets and isocyanurates. Diisocyanates may comprise, for example, toluene diisocyanate, 4,4′-methylene-bis-(cyclohexyl isocyanate), isophorone diisocyanate, an isomeric mixture of 2,2,4- and 2,4,4-trimethyl hexamethylene diisocyanate, 1,6-hexamethylene diisocyanate, tetramethyl xylylene diisocyanate and/or 4,4′-diphenylmethylene diisocyanate. Biurets of any suitable diisocyanate including, for example, 1,4-tetramethylene diisocyanate and 1,6-hexamethylene diisocyanate may be used. Also, biurets of cycloaliphatic diisocyanates such as isophorone diisocyanate and 4,4′-methylene-bis-(cyclohexyl isocyanate) may be employed. Examples of suitable aralkyl diisocyanates from which biurets may be prepared include meta-xylylene diisocyanate and α,α,α′,α′-tetramethylmeta-xylylene diisocyanate.

Trifunctional isocyanates may also be used as the curing agent, such as, for example, trimers of isophorone diisocyanate, hexamethylene diisocyanate, triisocyanato nonane, triphenylmethane triisocyanate, 1,3,5-benzene triisocyanate, 2,4,6-toluene triisocyanate, an adduct of trimethylol and tetramethyl xylene diisocyanate sold under the name CYTHANE 3160 by CYTEC Industries, and DESMODUR N 3300, which is the isocyanurate of hexamethylene diisocyanate, available from Covestro AG.

The polyisocyanate may also be one of those disclosed above, chain extended with one or more polyamines and/or polyols using suitable materials and techniques known to those skilled in the art to form a polyurethane prepolymer having isocyanate functional groups. Exemplary polyisocyanates are described in United States Patent Application Publication Number 2013/0344253 A1, paragraphs [0012]-[0033], incorporated herein by reference.

The curing agent may be present in the coating composition in an amount of at least 10% by weight, based on the total weight of the resin solids, such as at least 12%, such as at least 14% by weight, and may be present in an amount of no more than 80% by weight, such as no more than 50% by weight, such as no more than 40% by weight. The curing agent may be present in the coating composition in an amount of 10% by weight to 80% by weight, based on the total weight of the resin solids, such as 12% by weight to 50% by weight, such as 14% by weight to 40% by weight.

According to the present invention, the film-forming polymer may also be self-curing or self-condensing, i.e., self-crosslinking, and cure without requiring the presence of a curing agent. Accordingly, the coating composition may be substantially free, essentially free or completely free of a curing agent. As used herein, a coating composition is “substantially free” of curing agent if a curing agent is present in an amount of less than 5% by weight, based on the total weight of the resin solids. As used herein, a coating composition is “essentially free” of curing agent if a curing agent is present in an amount of less than 1% by weight, based on the total weight of the resin solids. As used herein, a coating composition is “completely free” of curing agent if a curing agent is not present in the coating composition, i.e., 0% by weight. Examples of self-curing film-forming polymers include polysiloxane polymers having alkoxysilane groups, as described above. Accordingly, the self-curing film-forming polymers may comprise a second functional group comprising, for example, an alkoxy silyl group. Suitable self-curing polysiloxane polymers are described in U.S. Pat. Nos. 5,275,645 and 5,618,860, each of which is incorporated by reference above.

When used in combination with the monomeric ionic liquid, the self-curing film-forming polymer may be present in the coating composition in an amount of at least 75% by weight, based on the total weight of the resin solids, such as at least 85%, such as at least 88% by weight, and may be present in an amount of no more than 99.5% by weight, such as no more than 97% by weight, such as no more than 95% by weight. The self-curing film-forming polymer may be present in the coating composition in an amount of 75% by weight to 99.5% by weight, based on the total weight of the resin solids, such as 85% by weight to 97% by weight, such as 88% by weight to 95% by weight.

When used in combination with the polymeric ionic liquid, the self-curing film-forming polymer may be present in the coating composition in an amount of in the coating composition in an amount of at least 50% by weight, based on the total weight of the resin solids, such as at least 60%, such as at least 65% by weight, and may be present in an amount of no more than 99.5% by weight, such as no more than 90% by weight, such as no more than 80% by weight. The self-curing film-forming polymer may be present in the coating composition in an amount of 50% by weight to 99.5% by weight, based on the total weight of the resin solids, such as 60% by weight to 90% by weight, such as 65% by weight to 80% by weight.

According to the present invention, the coating composition may optionally further comprise solvent. Any suitable solvent used in the art that is compatible with the components of the coating composition may be used. Nonlimiting examples of suitable organic solvents include aliphatic hydrocarbons, aromatic hydrocarbons, ketones, and esters. Nonlimiting examples of suitable aliphatic hydrocarbons include hexane, heptane, octane, and the like. Nonlimiting examples of suitable aromatic hydrocarbons include benzene, toluene, xylene, and the like. Nonlimiting examples of suitable ketones include methyl isobutyl ketone, diisobutyl ketone, methyl ethyl ketone, methyl hexyl ketone, ethyl butyl ketone, and the like. Nonlimiting examples of suitable esters include ethyl acetate, isobutyl acetate, amyl acetate, 2-ethylhexyl acetate, and the like. A mixture of solvents may also be used.

The amount of solvent present in the coating composition will be dependent up on the desired end use of the coating composition, such as whether the coating composition will be applied by spraying, brushing, or other suitable methods. For example, the solvent may be present in the coating composition in an amount of at least 0.1% by weight, based on the total weight of the coating composition, such as at least 12% by weight, such as at least 20% by weight, and may be present in an amount of no more than 30% by weight, such as no more than 28% by weight, such as no more than 26% by weight. The solvent may be present in the coating composition in an amount of 0.1% to 30% by weight, based on the total weight of the coating composition, such as 12% to 28% by weight, 20% to 26% by weight.

According to the present invention, the first functional group of the ionic liquid is reactive with at least one of the second functional group of the film-forming polymer or the third functional group of the curing agent. The first functional group of the ionic liquid may be reactive with both the second functional group of the film-forming polymer and the third functional group of the curing agent. The reactivity of the first functional group of the ionic liquid with the second functional group of the film-forming polymer and/or third functional group of the curing agent permits the ionic liquid to react with and be incorporated into the polymeric backbone of the polymeric matrix formed during cure of the coating composition.

According to the present invention, when the film-forming polymer is self-curing, the first functional group of the ionic liquid may be reactive with the second functional group of the film-forming polymer. Accordingly, the ionic liquid reacts with and be incorporated into the polymeric backbone of the polymeric matrix formed during cure of the self-curing coating composition.

Without being bound by any theory, it is believed that by incorporating the ionic liquid into the polymeric backbone of the cured coating, the coating retains the ionic liquid, including the salt group, for the duration of the life of the coating. It is further believed that the presence of the salt group functionality on the surface of the coating allows for favorable ice adhesion properties, such as, for example, reduced surface energy, reduced average maximum load required to remove ice from the surface of the coating, and reduced average maximum stress required to remove ice from the surface of the coating, as well as possibly resulting in freezing point depression of water on the surface of the coating. These “anti-icing” properties result in a mitigation of ice build-up on the surface of the coated substrate without the need for anti-icing treatments currently used in the art.

The average maximum load required to remove ice from the surface of the coating and the average maximum stress required to remove ice from the surface of the coating may be measured according to the Ice Adhesion Test more fully described in the Examples below.

According to the present invention, the average maximum load for ice adhesion as measured according to the Ice Adhesion Test may be reduced by at least 50%, such as at least 60%, such as at least 70%, such as at least 75%, and may be reduced by 50% to 90%, such as 60% to 90%, such as 70% to 90% for a coating formed from a coating composition comprising 5% by weight of the ionic liquid described above, based on the total weight of the resin solids, compared to a coating formed from a control coating composition that does not include an ionic liquid.

According to the present invention, the average maximum load for ice adhesion as measured according to the Ice Adhesion Test may be reduced by at least 50%, such as at least 60%, such as at least 70%, such as at least 75%, such as at least 80%, and may be reduced by 50% to 90%, such as 60% to 90%, such as 70% to 90% for a coating formed from a coating composition comprising 10% by weight of the ionic liquid described above, based on the total weight of the resin solids, compared to a coating formed from a control coating composition that does not include an ionic liquid.

According to the present invention, the average maximum stress for ice adhesion as measured according to the Ice Adhesion Test may be reduced by at least 50%, such as at least 70%, such as at least 75%, such as at least 80%, and may be reduced by 50% to 90%, such as 70% to 90%, such as 75% to 90%, such as 80% to 90% for a coating formed from a coating composition comprising 5% by weight of the ionic liquid described above, based on the total weight of the resin solids, compared to a coating formed from a control coating composition that does not include an ionic liquid.

According to the present invention, the average maximum stress for ice adhesion as measured according to the Ice Adhesion Test may be reduced by at least 50%, such as at least 70%, such as at least 75%, such as at least 80%, and may be reduced by 50% to 90%, such as 70% to 90%, such as 75% to 90%, such as 80% to 90% for a coating formed from a coating composition comprising 10% by weight of the ionic liquid described above, based on the total weight of the resin solids, compared to a coating formed from a control coating composition that does not include an ionic liquid.

According to the present invention, the coating composition may optionally comprise a silicone additive. The silicone additive may comprise any suitable silicone additive known in the art. For example, the silicone additive may comprise a silicone modified polymer comprising (i) pendant functional groups reactive with isocyanate functional groups and (ii) polysiloxane side chains. Alternatively, the silicone modified polymer may comprise alkoxy silyl groups in addition to polysiloxane side chains such that the silicone additive may react with the self-crosslinking film-forming polymer described above. Such polymers may comprise a plurality of polysiloxane side chains along the backbone of the polymer, as well as a plurality of pendant and/or terminal functional groups reactive with isocyanate functional groups. The pendent and/or terminal functional groups may comprise, for example, hydroxyl functional groups. The silicone modified polymer may comprise polyol polymers, acrylic polymers, polyester polymers, alkyd polymers, polyurethane polymers, polyamide polymers, polyether polymers, epoxy polymers, polysiloxane polymers, copolymers thereof, and mixtures thereof.

The silicone modified polymer may comprise a hydroxyl functional, silicone-modified acrylic polymer. Hydroxyl functional, silicone-modified acrylic polymers may demonstrate hydroxyl values of 5 to 100, such as 10 to 80, such as 20 to 60 mg KOH/g polymer. The weight average (M_{w}) molecular weight of the silicone-modified acrylic polymer may be 3,000 g/mol to 100,000 g/mol, such as 4,000 g/mol to 80,000 g/mol, such as 5,000 g/mol to 60,000 g/mol. The hydroxyl value may be determined by any suitable technique known in the art, such as, for example, ASTM E222. Suitable silicone-modified acrylic polymers are disclosed in U.S. Pat. No. 7,122,599, column 2, line 35-column 7, line 40, incorporated herein by reference. Commercially available silicone-modified acrylic polymers include BYK-Silclean 3700, a 25% solid content resin clear solution in 1-methoxy-2-propanol acetate with a hydroxyl value of 30 mg KOH/g based on the solid resin and weight average molecular weight of 15,000 g/mol, available from BYK Additives and Instruments.

The silicone additive may be present in the coating composition in an amount of at least 1% by weight, based on the total weight of the resin solids, such as at least 2% by weight, such as least 4% by weight and may be present in an amount of no more than 15% by weight, such as no more than 10% by weight, such as no more than 8% by weight. The silicone additive may be present in an amount of 1% by weight to 15% by weight, based on the total weight of the resin solids, such as 2% by weight to 10% by weight, such as 4% by weight to 8% by weight.

It has been surprisingly discovered that the combination of the ionic liquid and silicone additive in the coating composition of the present invention results in a synergistic effect on the ice adhesion properties of the cured coating. Incorporation of the ionic liquid and silicone additive in the amounts provided above may result in a reduction in the average maximum load and average maximum stress that is greater than the reduction in a coating that includes the ionic liquid or silicone additive alone. For example, the average maximum load as measured according to the Ice Adhesion Test may be reduced by at least 75%, such as at least 80%, such as at least 85%, and may be reduced by 75% to 95%, such as 85% to 95%; and the average maximum stress as measured according to the Ice Adhesion Test may be reduced by at least 75%, such as at least 80%, such as at least 85%, and may be reduced by 75% to 95%, such as 85% to 95%.

According to the present invention, the coating composition may optionally comprise a catalyst. The catalyst may promote the reaction of the film-forming polymer and curing agent. Additionally, the self-curing film-forming polymers may be combined with a catalyst for promoting hydrolysis and polycondensation of the polysiloxane polymer to effectuate cure. The catalyst may comprise any suitable catalyst known in the art that is compatible with the other components of the coating composition. Non-limiting examples of suitable catalysts include tertiary amine catalysts, nitrogen-containing heteroaromatic catalysts, metal compound catalysts, guanidine catalysts or a combination of catalysts to achieve the desired curing rate. Suitable tertiary amine catalysts include but are not limited to triethylamine, N-methylmorpholine, triethylenediamine, and the like. Suitable nitrogen-containing heteroaromatic catalysts include pyridine, picoline and the like. Suitable metal compound catalysts include but are not limited to compounds based on lead, zinc, cobalt, titanate, iron, copper and tin, such as lead 2-ethylhexonate, zinc 2-ethylhexonate, cobalt naphthenate, tetraisopropyl titanate, iron naphthenate, copper naphthenate, dibutyltin diacetate, dibutyltin dioctate, dibutyltin dilaurate and the like. Suitable guanidine catalysts include those described in U.S. Pat. No. 7,842,762, col. 1, line 53 through 3, line 45, the cited portion of which is incorporated herein by reference. These catalysts may be used alone or in combination.

The catalyst may be present in the coating composition in an amount of in the coating composition in an amount of at least 0.01% by weight, based on the total weight of the resin solids, such as at least 0.5%, such as at least 1% by weight, and may be present in an amount of no more than 5% by weight, such as no more than 3% by weight, such as no more than 2% by weight. The catalyst may be present in the coating composition in an amount of 0.01% by weight to 5% by weight, based on the total weight of the resin solids, such as 0.5% by weight to 3% by weight, such as 1% by weight to 2% by weight.

The coating composition may additionally include a variety of other optional ingredients and/or additives that are somewhat dependent on the particular application of the coating composition, such as other catalysts, pigments, colorants, fillers, reinforcements, thixotropes, accelerators, surfactants, plasticizers, extenders, stabilizers, corrosion inhibitors, diluents, hindered amine light stabilizers, UV light absorbers, and antioxidants.

According to the present invention, the coating composition may comprise a two-component, or “2K” composition. In a two-component coating composition, the resinous components (e.g., film-forming polymer) of the coating composition are maintained separately from the curing agent component until immediately prior to application of the coating composition. For example, the resinous components, such as the film-forming polymer (e.g., polyol polymer) and ionic liquid, and isocyanate curing agent of a polyurethane coating composition may be maintained separately until immediately prior to application. After application, the isocyanate curing agent and polyol polymer, as well as the ionic liquid, react to form a cured coating at ambient temperature.

According to the present invention, the coating composition may be a one-component, or “1K” composition. In a one-component coating composition, all of the components, including the film-forming polymer and curing agent are maintained together in the same dispersion. The curing agent may be a latent curing agent such that the curing agent does not react with the film-forming polymer during storage at ambient temperature. For example, the latent curing agent may comprise a blocked polyisocyanate that is not reactive without application of an external energy source, such as heat or UV radiation.

According to the present invention, the coating composition may be a clearcoat. A clearcoat will be understood as a coating that is substantially transparent or translucent. A clearcoat can therefore have some degree of color, provided it does not make the clearcoat opaque or otherwise affect, to any significant degree, the ability to see the underlying substrate. The clearcoats of the present invention can be used, for example, in conjunction with a pigmented basecoat. The clearcoat can be formulated as is known in the coatings art.

The present invention is also directed to a method of reducing ice adhesion to a substrate surface comprising applying the coating composition described above to a substrate and at least partially curing the coating composition to form a coating. The substrates that may be coated by the method of the present invention are not limited. Suitable substrates in the method of the present invention include rigid metal substrates such as ferrous metals, aluminum, aluminum alloys, copper, and other metal and alloy substrates. The ferrous metal substrates used in the practice of the present invention may include iron, steel, and alloys thereof. Non-limiting examples of useful steel materials include cold rolled steel, galvanized (zinc coated) steel, electrogalvanized steel, stainless steel, pickled steel, zinc-iron alloy such as GALVANNEAL, and combinations thereof. Combinations or composites of ferrous and non-ferrous metals can also be used. Aluminum alloys of the 2XXX, 5XXX, 6XXX, or 7XXX series as well as clad aluminum alloys and cast aluminum alloys of the A356 series also may be used as the substrate. Magnesium alloys of the AZ31B, AZ91C, AM60B, or EV31A series also may be used as the substrate. The substrate used in the present invention may also comprise titanium and/or titanium alloys. Other suitable non-ferrous metals include copper and magnesium, as well as alloys of these materials. Suitable metal substrates for use in the present invention include those that are used in the assembly of vehicular bodies (e.g., without limitation, door, body panel, trunk deck lid, roof panel, hood, roof and/or stringers, rivets, landing gear components, and/or skins used on an aircraft), a vehicular frame, vehicular parts, motorcycles, wheels, and industrial structures and components. As used herein, “vehicle” or variations thereof includes, but is not limited to, civilian, commercial and military aircraft, and/or land vehicles such as cars, motorcycles, and/or trucks. The metal substrate also may be in the form of, for example, a sheet of metal or a fabricated part. It will also be understood that the substrate may be pretreated with a pretreatment solution including a zinc phosphate pretreatment solution such as, for example, those described in U.S. Pat. Nos. 4,793,867 and 5,588,989, or a zirconium containing pretreatment solution such as, for example, those described in U.S. Pat. Nos. 7,749,368 and 8,673,091. The substrate may comprise a composite material such as a plastic or a fiberglass composite. The substrate may be a fiberglass and/or carbon fiber composite in the form of a wind blade. The method disclosed herein is also suitable for mitigating ice build-up on substrates used in turbines and aircraft parts such as airfoils, wings, stabilizers, rudders, ailerons, engine inlets, propellers, rotors, fuselage and the like, as well as other substrates that may encounter icy conditions.

Before depositing any coating compositions upon the surface of the substrate, it is common practice, though not necessary, to remove foreign matter from the surface by thoroughly cleaning and degreasing the surface. Such cleaning typically takes place after forming the substrate (stamping, welding, etc.) into an end-use shape. The surface of the substrate may be cleaned by physical and/or chemical means, such as mechanically abrading the surface or cleaning/degreasing with commercially available alkaline or acidic cleaning agents which are well known to those skilled in the art, such as sodium metasilicate and sodium hydroxide. A non-limiting example of a cleaning agent is CHEMKLEEN 163, an alkaline-based cleaner commercially available from PPG Industries, Inc.

Following the cleaning step, the substrate may be rinsed with deionized water, with a solvent, or an aqueous solution of rinsing agents in order to remove any residue. The substrate may be air dried, for example, by using an air knife, by flashing off the water by brief exposure of the substrate to a high temperature or by passing the substrate between squeegee rolls.

The substrate may be a bare, cleaned surface; it may be oily, pretreated with one or more pretreatment compositions, and/or prepainted with one or more coating compositions, primers, basecoats, topcoats, etc., applied by any method including, but not limited to, electrodeposition, spraying, dip coating, roll coating, curtain coating, and the like.

In the method of the present invention, the coating composition described above may be applied to at least a portion of one surface of the substrate and may be at least partially cured. A substrate may have one continuous surface, or two or more surfaces such as two opposing surfaces. Typically, the surface that is coated is any that may be expected to be exposed to conditions conducive to ice build-up, although the coating composition may be applied to any substrate. The coating composition may be applied to the substrate by one or more of a number of methods including spraying, dipping/immersion, brushing, or flow coating. After forming a film of the coating composition on the substrate, the coating composition may be cured by allowing it to stand at ambient temperature (e.g., 72° F., 22° C.), or a combination of ambient temperature cure and baking, or by baking alone. The composition may be cured at ambient temperature typically in a period ranging from about 24 hours to about 36 hours. If ambient temperature and baking are utilized in combination, the composition is typically allowed to stand for a period of from about 5 hours to about 24 hours followed by baking at a temperature up to about 140° F. (60° C.), for a period of time ranging from about 20 minutes to about 1 hour. The coating may also be cured by baking the substrate at an elevated temperature ranging from 60° C. to 260° C. for a time period ranging from 1 minute to 40 minutes. The coating layer formed from the coating composition may have a dry film thickness of 1-25 mils (25.4-635 microns), such as 5-25 mils (127-635 microns).

The present invention is also directed to a coating formed by coating composition of the present invention in an at least partially cured state.

The present invention is also directed to a coated substrate coated with the coating composition of the present invention in an at least partially cured state.

As used herein, the term “reactive” with respect to a functional group refers to a functional group capable of undergoing a chemical reaction with another functional group during typical curing conditions, such as, for example, spontaneously reacting when components are mixed or upon the application of an external energy source or in the presence of a catalyst or by any other means known to those skilled in the art.

As used herein, the term “cure”, “cured” or similar terms, as used in connection with the coating composition described herein, means that at least a portion of the components that form the coating composition are crosslinked to form a coating. Additionally, curing of the coating composition refers to subjecting said composition to curing conditions, such as those described above, leading to the reaction of the reactive functional groups of the components of the coating composition, and resulting in the crosslinking of the components of the composition and formation of a cured coating. The coating composition may be subjected to curing conditions until it is at least partially cured. As used herein, the term “at least partially cured” means subjecting the coating composition to curing conditions to form a coating, wherein reaction of at least a portion of the reactive groups of the components of the coating composition occurs. The coating composition may also be subjected to curing conditions such that a substantially complete cure is attained and wherein further curing results in no significant further improvement in the coating properties such as, for example, hardness.

As used herein, the “resin solids” include the ionic liquid, film-forming polymer, curing agent, any resin used in preparation of a pigment paste (if present), and any additional non-pigmented component(s).

For purposes of this detailed description, it is to be understood that the invention may assume various alternative variations and step sequences, except where expressly specified to the contrary. Moreover, other than in any operating examples, or where otherwise indicated, all numbers expressing, for example, quantities of ingredients used in the specification and claims are to be understood as being modified in all instances by the term “about”. Accordingly, unless indicated to the contrary, the numerical parameters set forth in the following specification and attached claims are approximations that may vary depending upon the desired properties to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard variation found in their respective testing measurements.

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

In this application, the use of the singular includes the plural and plural encompasses singular, unless specifically stated otherwise. For example, although reference is made herein to “an” ionic liquid, “a” film-forming polymer, “a” curing agent, or “a” functional group, a combination (i.e., a plurality) of these components can be used. In addition, in this application, the use of “or” means “and/or” unless specifically stated otherwise, even though “and/or” may be explicitly used in certain instances.

As used herein, “including,” “containing” and like terms are understood in the context of this application to be synonymous with “comprising” and are therefore open-ended and do not exclude the presence of additional undescribed or unrecited elements, materials, ingredients or method steps. As used herein, “consisting of” is understood in the context of this application to exclude the presence of any unspecified element, ingredient or method step. As used herein, “consisting essentially of” is understood in the context of this application to include the specified elements, materials, ingredients or method steps “and those that do not materially affect the basic and novel characteristic(s)” of what is being described.

As used herein, the terms “on,” “onto,” “applied on,” “applied onto,” “formed on,” “deposited on,” “deposited onto,” mean formed, overlaid, deposited, or provided on but not necessarily in contact with the surface. For example, a coating composition “deposited onto” a substrate does not preclude the presence of one or more other intervening coating layers of the same or different composition located between the coating composition and the substrate.

Whereas specific aspects of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the invention which is to be given the full breadth of the claims appended and any and all equivalents thereof.

### ASPECTS

1. A coating composition comprising:

an ionic liquid comprising a salt group and a first functional group;

a film-forming polymer comprising a second functional group; and

a curing agent comprising a third functional group;

wherein the first functional group is reactive towards at least one of the second functional group and the third functional group.

2. The coating composition of Aspect 1, wherein the salt group comprises pyridinium, pyrrolidinium, imidazolium, ammonium, guanidinium, phosphonium, isouronium, thiouronium or sulphonium.
3. The coating composition of Aspect 1 or 2, wherein the salt group comprises a halide, dicyanamide, tetrafluoroborate, hydrogen sulfate, methyl sulfate, octyl sulfate, hexafluorophosphate, bis(trifluoromethylsulfonyl)imide, tris(pentafluoroethyl)trifluorophosphate, trifluoromethanesulfonate, trifluoroacetate, thiocyanate, organoborate, and p-toluenesulfonate.
4. The coating composition of any of the preceding Aspects, wherein the ionic liquid comprises a salt group comprising imidazolium and chloride.
5. The coating composition of Aspect of any of the preceding Aspects, wherein the ionic liquid comprises the structure according to formula (I):

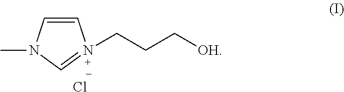

6. The coating composition of any of Aspects 1-4, wherein the ionic liquid comprises the structure according to formula (II):

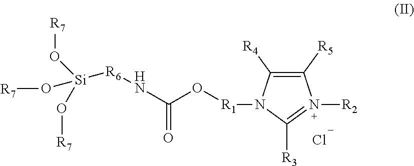

wherein R₁ is a substituted or unsubstituted C₁-C₃₆ alkanediyl group or a substituted or unsubstituted C₆-C₃₆ divalent aromatic group;

R₂ is hydrogen, a substituted or unsubstituted C₁-C₃₆ alkyl group or a substituted or unsubstituted C₆-C₃₆ aromatic group;

R₃ is hydrogen or a substituted or unsubstituted C₁-C₃₆ alkyl group;

R₄ is hydrogen or a substituted or unsubstituted C₁-C₃₆ alkyl group;

R₅ is hydrogen or a substituted or unsubstituted C₁-C₃₆ alkyl group;

R₆ is a substituted or unsubstituted C₁-C₃₆ alkanediyl group, a linear or branched C₃ to C₃₆ cycloaliphatic group, or a linear or branched C₆ to C₃₆ aromatic group; and

R₇ is a substituted or unsubstituted C₁-C₄ alkyl group.

7. The coating composition of any of Aspects 1-4, wherein the ionic liquid comprises the structure according to formula (III):

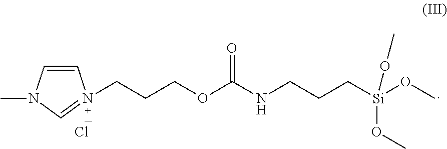

8. The coating composition of any of Aspects 1-4, wherein the ionic liquid comprises the structure according to formula (IV):

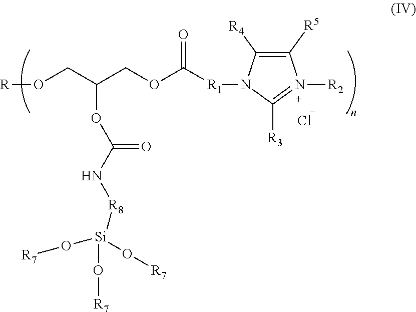

wherein n≥1;

R comprises a monovalent or polyvalent, substituted or unsubstituted C₁-C₃₆ alkane group, a monovalent or polyvalent C₆-C₃₆ aromatic group, a monovalent or polyvalent C₃-C₃₆ cycloaliphatic group, a monovalent or polyvalent polyester group having a number average molecular weight (Mₙ) of greater than 200 g/mol, a monovalent or polyvalent polyether group having a number average molecular weight (Mₙ) of greater than 200 g/mol, a monovalent or polyvalent acrylic resin having a number average molecular weight (Mₙ) of greater than 500 g/mol, or a monovalent or polyvalent polyurethane group having a number average molecular weight (Mₙ) of greater than 500 g/mol;

R₁ is a substituted or unsubstituted C₁-C₃₆ alkanediyl group or a substituted or unsubstituted C₆-C₃₆ divalent aromatic group;

R₂ is hydrogen, a substituted or unsubstituted C₁-C₃₆ alkyl group, or a substituted or unsubstituted C₆-C₃₆ aromatic group;

R₃ is hydrogen or a substituted or unsubstituted C₁-C₃₆ alkyl group;

R₄ is hydrogen or a substituted or unsubstituted C₁-C₃₆ alkyl group;

R₅ is hydrogen or a substituted or unsubstituted C₁-C₃₆ alkyl group;

R₆ is a C₁ to C₃₆ alkanediyl group, a linear or branched C₃ to C₃₆ cycloaliphatic group, or a linear or branched C₆ to C₃₆ aromatic group; and

R₇ is a substituted or unsubstituted C₁-C₄ alkyl group.

9. The coating composition of any of the preceding Aspects, wherein the ionic liquid is substantially free of alkali metals and alkaline earth metals.
10. The coating composition of any of the preceding Aspects, wherein the first functional group comprises a hydroxyl or an alkoxy silyl group.
11. The coating composition of any of the preceding Aspects, wherein the second functional group comprises a hydroxyl group, epoxy group, siloxane group, or combinations thereof.
12. The coating composition of any of the preceding Aspects, wherein the film-forming polymer includes at least two of the second functional group per molecule.
13. The coating composition of any of the preceding Aspects, wherein the third functional group comprises an isocyanato group, an amino group, or combinations thereof.
14. The coating composition of any of the preceding Aspects, wherein the curing agent comprises at least two of the third functional group per molecule.
15. The coating composition of any of the preceding Aspects further comprising a silicone additive.
16. The coating composition of any of the preceding Aspects, wherein an at least partially cured coating formed from the coating composition of any of the preceding Aspects comprising 5% ionic liquid by weight, based on the total weight of the resin solids, has an average maximum load reduced by at least 50% compared to an at least partially cured coating formed from a coating composition that does not include the ionic liquid, as measured according to Ice Adhesion Test.
17. The coating composition of any of the preceding Aspects, wherein an at least partially cured coating formed from the coating composition of any of the preceding Aspects comprising 5% ionic liquid by weight, based on the total weight of the resin solids, has an average maximum stress reduced by at least 50% compared to an at least partially cured coating formed from a coating composition that does not include the ionic liquid, as measured according to Ice Adhesion Test.
18. A coating composition comprising:

an ionic liquid comprising a salt group and a first functional group; and

a self-curing film-forming polymer comprising a second functional group;

wherein the first functional group is reactive towards the second functional group.

19. A method of reducing ice adhesion to a substrate surface comprising applying the coating composition of any of the preceding Aspects to the surface of the substrate and at least partially curing the coating composition to form a coating. Herein ice adhesion at the coated substrate surface is reduced in comparison to the uncoated substrate surface and preferably also in comparison to a substrate coated with essentially the same coating expect that the latter does not contain the ionic liquid.
20. A coating formed by the coating composition of any of the preceding Aspects in an at least partially cured state.
21. A substrate coated with the coating composition of any of the preceding Aspects in an at least partially cured state.

Illustrating the invention are the following examples, which, however, are not to be considered as limiting the invention to their details. Unless otherwise indicated, all parts and percentages in the following examples, as well as throughout the specification, are by weight.

### EXAMPLES

### Ionic Liquid Synthesis Examples

### Example A

Synthesis of Alkoxysilane Functional Methylimidazolium Chloride Ionic Liquid:

Into a 500-mililiter, 4-necked kettle equipped with a stirrer, a condenser, a nitrogen inlet, and a thermocouple in a heating mantle, was charged 3-chloro-1-propanol (46.23 g, 0.489 mol, commercially available from Aldrich), toluene (110 mL) and dibutyltin dilaurate (0.028 g, commercially available from Air Product & Chemicals). Agitation by an air motor and a nitrogen flow of 0.2 scft/min through the nitrogen inlet were started. The reaction mixture was heated to 70° C. At 70° C., isocyanatopropyl trimethoxy silane (109.2 g, 0.533 mol, commercially available from Momentive) was added into reaction mixture drop wise over 30 minutes via an addition funnel. Toluene (11 mL) was then used to rinse the addition funnel. The reaction mixture was held until the isocyanate peak at 2259 cm⁻¹ was no longer detected by a Thermo Scientific Nicolet iS5 FT-IR Spectrometer. After the reaction was completed (approximately 3 hours), N-methyl imidazole (39.75 g, 0.484 mol, commercially available from Aldrich) was added into reaction mixture dropwise over 10 minutes. After addition, the reaction mixture was heated to reflux and held for 4 hours. The reaction mixture was then allowed to cool to 80° C. and the agitation was stopped. After 10 minutes, the reaction mixture separated into two phases. The solvent phase was removed by decanting. Additional toluene remaining in the aqueous phase was removed by vacuum distillation. An orange oil was obtained.

### Example B

Synthesis of Hydroxyl Functional Methylimidazolium Chloride Ionic Liquid:

Into a 500-mililiter, 4-necked kettle equipped with a stirrer, a condenser, a nitrogen inlet, and a thermocouple in a heating mantle, was charged of 3-chloro-1-propanol (72.55 g, 0.7674 mol, commercially available from Aldrich), N-methylimidazole (60 g, 0.7308 mol, commercially available from Aldrich), and toluene (120 mL). Agitation by an air motor and a nitrogen flow of 0.2 scft/min were started. The reaction mixture was heated to reflux for 4 hours. The reaction mixture was allowed to cool to 70° C. and agitation was stopped. After 10 minutes, the reaction mixture separated into two phases. The solvent phase was removed by decanting. Additional toluene remaining in the aqueous phase was removed by vacuum distillation. An orange oil was obtained.

### Example C

Synthesis of Polymeric Alkoxysilane Functional Ionic Liquid:

Into a 500-mililiter, 4-necked kettle equipped with a stirrer, a condenser, a nitrogen inlet, and a thermocouple in a heating mantle, was charged Eponex™ 1510 (115.10 g, bisphenol A-type epoxy-resin commercially available from Hexion Specialty Chemicals), toluene (107.20 mL), 2-chloroacetic acid (45.77 g, commercially available from Sigma Aldrich), and ethyltriphenylphosphonium iodide (ETPPI, 0.20 g, commercially available from Dow Chemical Co). Agitation by an air motor and a nitrogen flow of 0.2 scft/min through the nitrogen inlet were started. The reaction mixture was gradually heated to 130° C. The reaction was held at 130° C. for 13 hours until the acid value was less than 2. The acid value was determined by titration using a Metrohm 888 Titrando and 0.1 N KOH solution in methanol as the titration reagent. The reaction mixture was then cooled to 70° C. When the reaction temperature reached 70° C., dibutyltin dilaurate (0.046 g, commercially available from Air Products & Chemicals) was added to the reaction mixture. Isocyanatopropyl trimethoxy silane (99.25 grams, commercially available from Momentive) was then added into reaction mixture drop wise over 30 minutes through an addition funnel. Toluene (10 mL) was then used to rinse the addition funnel. The reaction mixture was held at 70° C. for 6 hours and the isocyanate equivalent weight was determined by reacting a sample of the isocyanate with a known excess of dibutylamine in N-methyl-2-pyrrolidone and determining the excess dibutylamine by potentiometric titration using a Metrohm 888 Titrando and 0.2N hydrochloric acid in isopropanol. The isocyanate equivalent weight was determined to be 3,038 g/eq. After calculation based on isocyanate equivalent, chloropropanol (8.0 g, commercially available from Sigma-Aldrich) was added to the reaction mixture. The reaction mixture was held until the isocyanate peak at 2259 cm⁻¹ was no longer detected by a Thermo Scientific Nicolet iS5 FT-IR Spectrometer. After the reaction was completed (approximately 1 hour), N-methyl imidazole (39.75 g, 0.484 mol, commercially available from Aldrich) was added into the reaction mixture dropwise over 10 minutes. After addition, the reaction mixture was heated to reflux and held for 5 hours. After holding, the reaction mixture was then allowed to cool to 80° C. and the agitation was stopped. After 10 minutes, the reaction mixture separated into two phases. The solvent phase was removed by decanting. The remaining solvent was removed by vacuum distillation. An orange oil was obtained.

### Paint Examples

Aluminum panels having a mill finish were used as test substrates. The panels had dimensions of 0.25″×4″×12″. A two-component epoxy-amine primer, CA 7502 (available from PPG Industries), was hand sprayed onto one side of the panel with a DeVilbiss GTI spray gun having a 2.0 tip at 40 psi. The primer coating was applied at 1.0 mils dry-film thickness (“DFT”) (±0.2 mils) and allowed to dry at room temperature (about 25° C.) for four hours. The same epoxy-amine primer was applied in the same manner to the other side of the panel and allowed to dry at room temperature (about 25° C.) for four hours. Control or experimental topcoats were then applied onto the primed panels.

### Example 1

The alkoxysilane functional methylimidazolium chloride ionic liquid of Example A was added to a two-component polyurethane topcoat coating composition to form experimental coating compositions. A control polyurethane coating composition having no ionic liquid was also used. The two-component polyurethane topcoat coating composition used was DESOTHANE® CA 8800 (available from PPG Industries). The polyol base was combined with the solvent according to the manufacturer's instructions. For the experimental coating compositions, either 5% or 10% by weight of the ionic liquid of Example A, based on the total weight of the base resin and crosslinker and resulting in 4.76% and 9.09%, respectively by weight of the ionic liquid based on the total resin solids, was added to the pre-mixed polyol base and solvent under agitation from a Fawcett air motor, model #103A, using a high lift blade. Agitation was continued for five minutes on low speed after the ionic liquid addition was complete. The agitation was then stopped and the mixture was allowed to equilibrate for about twenty minutes. The crosslinker was then added to the mixture and the mixture was shaken by hand for about two minutes until the mixture appeared to be visually consistent. After the components were mixed, the coating composition was filtered into the spray gun described below through a Gerson Elite paint strainer having a mesh size of 260 microns. The components of the coating compositions evaluated are shown in Table 1A below.

TABLE 1A

| | | | 4.76% Ionic | | 9.09% Ionic | |
|---|---|---|---|---|---|---|
| | Control | | Liquid Addition | | Liquid Addition | |
| | Total | Resin | Total | Resin | Total | Resin |
| | weight | Solids | weight | Solids | weight | Solids |
| Components: | (g) | (g) | (g) | (g) | (g) | (g) |
| CA 8800A | 131.25 | 77.71 | 131.25 | 77.71 | 131.25 | 77.71 |
| (Polyol Base, | | | | | | |
| pigment and | | | | | | |
| additives) | | | | | | |
| Ionic Liquid of | — | — | 6.55 | 6.55 | 13.1 | 13.1 |
| Example A | | | | | | |
| CA 8800B | 53.24 | 53.24 | 53.24 | 53.24 | 53.24 | 53.24 |
| (Crosslinker) | | | | | | |
| CA 8800C | 53.2 | 0 | 53.2 | 0 | 53.2 | 0 |
| (Solvent) | | | | | | |
| Total: | 237.7 | 130.9 | 244.3 | 137.5 | 250.8 | 144.0 |

| | | | |
|---|---|---|---|
| Equivalents of | 0.000 | 0.017 | 0.034 |
| salt groups per | | | |
| gram total resin | | | |
| solids | | | |

The control and experimental topcoat coating compositions were hand sprayed onto one side of the primed panel with a DeVilbiss GTI spray gun having a 2.0 tip at 40 psi. The topcoat coating composition was applied at 2.0 mils dry-film thickness (±0.2 mils) and allowed to dry at room temperature (about 25° C.) for four hours. The topcoat coating composition was applied in the same manner to the other side of the panel and allowed to dry at room temperature (about 25° C.) for four hours. The panels were then allowed to cure at room temperature (about 25° C. and 40% relative humidity) for seven days prior to testing.

A Krüss Drop Shape Analyzer DSA100 was used to measure the contact angle and surface energy of the cured coatings. The panels were mounted onto a sample stage and a 2 μL droplet of water was deposited onto the coating. An automated baseline is determined by where the three phrases of a solid, liquid and gas intersect, and the angle of contact of the water droplet to the coating is measured. The test was repeated with three more droplets of water and the results were averaged to determine the contact angle of water on the surface of the coating. This process was repeated using methylene iodide instead of water to determine the contact angle of methylene iodide on the surface of the coating. The surface energy was calculated using the contact angle of water and methylene iodide and Young's equation. The results of these tests are provided in Table 1B below.

Ice adhesion was measured according to an “Ice Adhesion Test” defined as having the following procedure: Each coated panel was cut into five 1″×4″ strips and placed into a CREEL fixture and secured in the fixture with 2″ duct tape starting ½″ from the top of each side of the fixture so that a 1″ water-tight cavity was formed. The cavity was filled to the top with chilled deionized water that had been placed in a freezer set to −15° C. to −20° C. for about 60 minutes. The filled CREEL fixture was then placed into a −20° C. freezer overnight to thoroughly freeze the panel in the ice. An Instron 5567 equipped with an Environmental Chamber set to −20° C. was used to measure the average maximum load and the average maximum stress of ice adhesion for each of the five panels. The test fixture was mounted such that the fixed end of the tensile tester is connected to the test fixture and the movable jaw is connected to the test panel. This testing setup creates a relative motion between the test strip and the ice that was formed from the water. The tape that held the water in place was removed and then, using a constant extension rate, the maximum force and maximum stress required to remove the panel from the ice was recorded. Each of the five panels for each coating variation was tested and an average maximum load and average maximum stress reported. The results of this testing are included below in Table 1B.

TABLE 1B

| | | | | | | Average | |
|---|---|---|---|---|---|---|---|
| | Contact Angle | | | Average | Std. Dev. | Maximum | Std. Dev. |
| | | Methylene | Surface | Maximum | Maximum | Stress | Maximum |
| | Water | Iodide | Energy | Load (N) | Load | (KPa) | Stress |
| Control | 84.2 | 47.2 | 43.32 | 1170.9 | 313.7 | 907.13 | 242.7 |
| 4.76% Ionic | 79.3 | 46.4 | 21.03 | 264.6 | 48.0 | 205.1 | 37.9 |
| Liquid | | | | | | | |
| Addition | | | | | | | |
| 9.09% Ionic | 76.4 | 71.4 | 20.9 | 187.9 | 49.52 | 151.7 | 41.4 |
| Liquid | | | | | | | |
| Addition | | | | | | | |

As shown in Table 1B, the inclusion of the ionic liquid at 5% and 10% by weight resulted in cured coatings having a reduced surface energy, and reduced average maximum load and average maximum stress for ice release than a comparative coating that did not include the ionic liquid.

### Example 2

The alkoxysilane functional methylimidazolium chloride ionic liquid of Example A was added to a two-component polysiloxane topcoat coating composition to form experimental coating compositions. A control polysiloxane coating composition having no ionic liquid was also used. The two-component polysiloxane topcoat coating composition used was PSX 700 (available from PPG Industries). For the experimental coating compositions, either 5% or 10% by weight of the ionic liquid of Example A, based on the total weight of the base resin and crosslinker and resulting in 6.53% and 12.27%, respectively, by weight of the ionic liquid based on the total resin solids, was added to the polysiloxane base component under agitation from a Fawcett air motor, model #103A, using a high lift blade. Agitation was continued for five minutes on low speed after the ionic liquid addition was complete. The agitation was then stopped and the mixture was allowed to equilibrate for about twenty minutes. The crosslinker was then added to the mixture and the mixture was shaken by hand for about two minutes until the mixture appeared to be visually consistent. After the components were mixed, the coating composition was filtered into the spray gun described below through a Gerson Elite paint strainer having a mesh size of 260 microns. The components of the coating compositions evaluated are shown in Table 2A below.

TABLE 2A

| | | | 6.53% Ionic | | 12.27% Ionic | |
|---|---|---|---|---|---|---|
| | Control | | Liquid Addition | | Liquid Addition | |
| | Total | Resin | Total | Resin | Total | Resin |
| | weight | Solids | weight | Solids | weight | Solids |
| Components: | (g) | (g) | (g) | (g) | (g) | (g) |
| PSX 700 | 100 | 66.9 | 100 | 66.9 | 100 | 66.9 |
| (Polysiloxane | | | | | | |
| Base, pigment | | | | | | |
| and additives) | | | | | | |
| Ionic Liquid of | — | — | 5.81 | 5.81 | 11.63 | 11.63 |
| Example A | | | | | | |
| PSX 700 Cure | 16.26 | 16.26 | 16.26 | 16.26 | 16.26 | 16.26 |
| (Crosslinker) | | | | | | |
| Total: | 116.26 | 83.16 | 122.07 | 88.98 | 127.89 | 94.79 |

| | | | |
|---|---|---|---|
| Equivalents of | 0.000 | 0.015 | 0.030 |
| salt groups per | | | |
| gram total resin | | | |
| solids | | | |

The control and experimental topcoat coating compositions were hand sprayed onto one side of the primed panel with a DeVilbiss GTI spray gun having a 2.0 tip at 40 psi. The topcoat coating composition was applied at 2.0 mils dry-film thickness (“DFT”) (±0.2 mils) and allowed to dry at room temperature (about 25° C.) for four hours. The topcoat coating composition was applied in the same manner to the other side of the panel and allowed to dry at room temperature (about 25° C.) for four hours. The panels were then allowed to cure at room temperature (about 25° C. and 40% relative humidity) for seven days prior to testing.

The contact angle, surface energy, and ice adhesion properties of the cured coatings were measured as described above in Example 1. The results of this testing are included below in Table 2B.

TABLE 2B

| | | | | | | Average | |
|---|---|---|---|---|---|---|---|
| | Contact Angle | | | Average | Std. Dev. | Maximum | Std. Dev. |
| | | Methylene | Surface | Maximum | Maximum | Stress | Maximum |
| | Water | Iodide | Energy | Load (N) | Load | (KPa) | Stress |
| Control | 87.2 | 37.9 | 40.66 | 586.8 | 57.1 | 454.7 | 44.3 |
| 5% Ionic | 92.0 | 43.0 | 37.85 | 194.54 | 32.2 | 105.8 | 24.9 |
| Liquid | | | | | | | |
| Addition | | | | | | | |
| 10% Ionic | 85.0 | 45.1 | 35.94 | 161.2 | 5.4 | 124.9 | 4.2 |
| Liquid | | | | | | | |
| Addition | | | | | | | |

As shown in Table 2B, the inclusion of the ionic liquid at 5% and 10% by weight resulted in cured coatings having a reduced surface energy, and reduced average maximum load and average maximum stress for ice release than a comparative coating that did not include the ionic liquid.

### Example 3

The hydroxyl functional methylimidazolium chloride ionic liquid of Example B and a silicone additive was added to a two-component polyurethane topcoat coating composition to form an experimental coating composition. A control polyurethane coating composition having no ionic liquid or silica was also used. The two-component polyurethane topcoat coating composition used was DESOTHANE® CA 8925 (available from PPG Industries). The polyol base was combined with the solvent according to the manufacturer's instructions. For the experimental coating composition, 7% by weight of the ionic liquid of Example B and 5.8% by weight of a silicone additive (BYK-Silclean 3700, available from BYK Additives and Instruments), based on the total weight of the base resin and crosslinker and resulting in 7.39% by weight ionic liquid and 6.27% by weight of silicone additive based on the total resin solids, were added to the pre-mixed polyol base and solvent under agitation from a Fawcett air motor, model #103A, using a high lift blade. Agitation was continued for five minutes on low speed after the ionic liquid and silicone additive addition were complete. The agitation was then stopped and the mixture was allowed to equilibrate for about twenty minutes. The crosslinker was then added to the mixture and the mixture was shaken by hand for about two minutes until the mixture appeared to be visually consistent. After the components were mixed, the coating composition was filtered into the spray gun described below through a Gerson Elite paint strainer having a mesh size of 260 microns. The components of the coating compositions evaluated are shown in Table 3A below.

TABLE 3A

| | | | 7.39% Ionic Liquid | |
|---|---|---|---|---|
| | | | and 6.27% Silicone | |
| | Control | | Additive Additions | |
| | Total | Resin | Total | Resin |
| Components: | weight (g) | Solids (g) | weight (g) | Solids (g) |
| CA 8925A (Polyol | 40.88 | 30.39 | 40.88 | 30.39 |
| Base, pigment and | | | | |
| additives) | | | | |
| BYK-Silclean 3700¹ | — | — | 14.5 | 3.39 |
| (Hydroxyl-functional | | | | |
| Silicone Additive) | | | | |
| Ionic Liquid of | — | — | 4.0 | 4.0 |
| Example B | | | | |
| CA 8925B | 16.33 | 16.33 | 16.33 | 16.33 |
| (Crosslinker) | | | | |
| CA 8925C (Solvent) | 12.06 | 0 | 12.06 | 0 |
| Total: | 69.27 | 46.72 | 87.77 | 54.11 |

| | | |
|---|---|---|
| Equivalents of salt | 0.000 | 0.023 |
| groups per gram total | | |
| resin solids | | |

¹Available from BYK Additives and Instruments; containing 25.00% non-volatile matter.

The control and experimental topcoat coating compositions were hand sprayed onto one side of the primed panel with a DeVilbiss GTI spray gun having a 2.0 tip at 40 psi. The topcoat coating composition was applied at 2.0 mils dry-film thickness (±0.2 mils) and allowed to dry at room temperature (about 25° C.) for four hours. The topcoat coating composition was applied in the same manner to the other side of the panel and allowed to dry at room temperature (about 25° C.) for four hours. The panels were then allowed to cure at room temperature (about 25° C. and 40% relative humidity) for seven days prior to testing.

The contact angle, surface energy, and ice adhesion properties of the cured coatings were measured as described above in Example 1. The results of this testing are included below in Table 3B.

TABLE 3B

| | | | | | | Average | |
|---|---|---|---|---|---|---|---|
| | Contact Angle | | | Average | Std. Dev. | Maximum | Std. Dev. |
| | | Methylene | Surface | Maximum | Maximum | Stress | Maximum |
| | Water | Iodide | Energy | Load (N) | Load | (KPa) | Stress |
| Control | 84.5 | 27.2 | 45.36 | 843.12 | 36.21 | 653.42 | 28.06 |
| 7% Ionic | 103.1 | 75.6 | 19.95 | 86.71 | 15.37 | 67.14 | 11.99 |
| Liquid and | | | | | | | |
| 5.8% | | | | | | | |
| Silicone | | | | | | | |
| Additive | | | | | | | |
| Addition | | | | | | | |

As shown in Table 3B, the inclusion of the ionic liquid at 7% by weight and the silicone additive at 5.8% by weight resulted in cured coatings having a reduced surface energy, and reduced average maximum load and average maximum stress for ice release than a comparative coating that did not include the ionic liquid.

### Example 4

The hydroxyl functional methylimidazolium chloride ionic liquid of Example B was added to a two-component polyurethane topcoat coating composition to form experimental coating compositions. A control polyurethane coating composition having no ionic liquid was also used. The two-component polyurethane topcoat coating composition used was CA 8800 (available from PPG Industries). The polyol base was combined with the solvent according to the manufacturer's instructions. For the experimental coating compositions, either 5% or 10% by weight of the ionic liquid of Example B, based on the total weight of the base resin and crosslinker and resulting in 4.76% and 9.09% by weight of the ionic liquid based on the total resin solids, was added to the pre-mixed polyol base and solvent under agitation from a Fawcett air motor, model #103A, using a high lift blade. Agitation was continued for five minutes on low speed after the ionic liquid addition was complete. The agitation was then stopped and the mixture was allowed to equilibrate for about twenty minutes. The crosslinker was then added to the mixture and the mixture was shaken by hand for about two minutes until the mixture appeared to be visually consistent. After the components were mixed, the coating composition was filtered into the spray gun described below through a Gerson Elite paint strainer having a mesh size of 260 microns. The components of the coating compositions evaluated are shown in Table 4A below.

TABLE 4A

| | | | 4.76% Ionic | | 9.09% Ionic | |
|---|---|---|---|---|---|---|
| | Control | | Liquid Addition | | Liquid Addition | |
| | Total | Resin | Total | Resin | Total | Resin |
| | weight | Solids | weight | Solids | weight | Solids |
| Components: | (g) | (g) | (g) | (g) | (g) | (g) |
| CA 8800A | 131.25 | 77.71 | 131.25 | 77.71 | 131.25 | 77.71 |
| (Polyol Base, | | | | | | |
| pigment and | | | | | | |
| additives) | | | | | | |
| Ionic Liquid of | — | — | 6.55 | 6.55 | 13.1 | 13.1 |
| Example B | | | | | | |
| CA 8800B | 53.24 | 53.24 | 53.24 | 53.24 | 53.24 | 53.24 |
| (Crosslinker) | | | | | | |
| CA 8800C | 53.24 | 0 | 53.24 | 0 | 53.24 | 0 |
| (Solvent) | | | | | | |
| Total: | 237.73 | 130.95 | 244.28 | 137.50 | 250.83 | 144.05 |

| | | | |
|---|---|---|---|
| Equivalents of | 0.000 | 0.037 | 0.074 |
| salt groups per | | | |
| gram total resin | | | |
| solids | | | |

The control and experimental topcoat coating compositions were hand sprayed onto one side of the primed panel with a DeVilbiss GTI spray gun having a 2.0 tip at 40 psi. The topcoat coating composition was applied at 2.0 mils dry-film thickness (“DFT”) (±0.2 mils) and allowed to dry at room temperature (about 25° C.) for four hours. The topcoat coating composition was applied in the same manner to the other side of the panel and allowed to dry at room temperature (about 25° C.) for four hours. The panels were then allowed to cure at room temperature (about 25° C. and 40% relative humidity) for seven days prior to testing.

The contact angle, surface energy, and ice adhesion properties of the cured coatings were measured as described above in Example 1. The results of this testing are included below in Table 4B.

TABLE 4B

| | | | | | | Average | |
|---|---|---|---|---|---|---|---|
| | Contact Angle | | | Average | Std. Dev. | Maximum | Std. Dev. |
| | | Methylene | Surface | Maximum | Maximum | Stress | Maximum |
| | Water | Iodide | Energy | Load (N) | Load | (KPa) | Stress |
| Control | 87.2 | 37.9 | 40.66 | 586.8 | 57.1 | 454.7 | 44.3 |
| 5% Ionic | 92.0 | 43.0 | 37.85 | 194.54 | 32.2 | 105.8 | 24.9 |
| Liquid | | | | | | | |
| Addition | | | | | | | |
| 10% Ionic | 85.0 | 45.1 | 35.94 | 161.2 | 5.4 | 124.9 | 4.2 |
| Liquid | | | | | | | |
| Addition | | | | | | | |

As shown in Table 4B, the inclusion of the ionic liquid at 5% and 10% by weight resulted in cured coatings having a reduced surface energy, and reduced average maximum load and average maximum stress for ice release than a comparative coating that did not include the ionic liquid.

### Example 5

The polymeric alkoxysilane functional ionic liquid of Example C was added to a two-component polysiloxane topcoat coating composition to form experimental coating compositions. A control polysiloxane coating composition having no ionic liquid was also used. The two-component polysiloxane topcoat coating composition used was PSX 700 (available from PPG Industries). For the experimental coating compositions, either 21% or 29% by weight of the ionic liquid of Example C, based on the total weight of the base resin and crosslinker and resulting in 21.55% and 29.17%, respectively by weight of the ionic liquid based on the total resin solids, was added to the polysiloxane base component under agitation from a Fawcett air motor, model #103A, using a high lift blade. Agitation was continued for five minutes on low speed after the ionic liquid addition was complete. The agitation was then stopped and the mixture was allowed to equilibrate for about twenty minutes. The crosslinker was then added to the mixture and the mixture was shaken by hand for about two minutes until the mixture appeared to be visually consistent. After the components were mixed, the coating composition was filtered into the spray gun described below through a Gerson Elite paint strainer having a mesh size of 260 microns. The components of the coating compositions evaluated are shown in Table 5A below.

TABLE 5A

| | | | 21.55% | | 29.15% | |
|---|---|---|---|---|---|---|
| | | | Polymeric Ionic | | Polymeric Ionic | |
| | Control | | Liquid Addition | | Liquid Addition | |
| | Total | Resin | Total | Resin | Total | Resin |
| | weight | Solids | weight | Solids | weight | Solids |
| Components: | (g) | (g) | (g) | (g) | (g) | (g) |
| PSX 700 | 100 | 62.17 | 100 | 62.17 | 100 | 62.17 |
| (Polysiloxane | | | | | | |
| Base, pigment | | | | | | |
| and additives) | | | | | | |
| Polymeric | — | — | 21.54 | 21.54 | 32.3 | 32.3 |
| Ionic Liquid of | | | | | | |
| Example C | | | | | | |
| PSX 700 Cure | 16.26 | 16.26 | 16.26 | 16.26 | 16.26 | 16.26 |
| (Crosslinker) | | | | | | |
| Total: | 116.26 | 78.43 | 137.8 | 99.97 | 148.56 | 110.73 |

The control and experimental topcoat coating compositions were hand sprayed onto one side of the primed panel with a DeVilbiss GTI spray gun having a 2.0 tip at 20 psi. The topcoat coating composition was applied at 2.0 mils dry-film thickness (“DFT”) (±0.2 mils) and allowed to dry at room temperature (about 25° C.) for four hours. The topcoat coating composition was applied in the same manner to the other side of the panel and allowed to dry at room temperature (about 25° C.) for four hours. The panels were then allowed to cure at room temperature (about 25° C. and 40% relative humidity) for seven days prior to testing.

The contact angle, surface energy, and ice adhesion properties of the cured coatings were measured as described above in Example 1. The results of this testing are included below in Table 5B.

TABLE 5B

| | | | | | | Average | |
|---|---|---|---|---|---|---|---|
| | Contact Angle | | | Average | Std. Dev. | Maximum | Std. Dev. |
| | | Methylene | Surface | Maximum | Maximum | Stress | Maximum |
| | Water | Iodide | Energy | Load (N) | Load | (KPa) | Stress |
| Control | 99.5 | 43.8 | 38.27 | 953.78 | 19.23 | 739.18 | 14.91 |
| 21% | 73.8 | 16 | 49.87 | 706.48 | 85.38 | 547.52 | 66.17 |
| Polymeric | | | | | | | |
| Ionic | | | | | | | |
| Liquid | | | | | | | |
| Addition | | | | | | | |
| 30% | 79.7 | 17.6 | 48.67 | 590.19 | 82.12 | 457.40 | 63.64 |
| Polymeric | | | | | | | |
| Ionic | | | | | | | |
| Liquid | | | | | | | |
| Addition | | | | | | | |

As shown in Table 5B, the inclusion of the polymeric ionic liquid at 21% and 30% by weight resulted in cured coatings having a reduced average maximum load and average maximum stress for ice release than a comparative coating that did not include the polymeric ionic liquid.

It will be appreciated by skilled artisans that numerous modifications and variations are possible in light of the above disclosure without departing from the broad inventive concepts described and exemplified herein. Accordingly, it is therefore to be understood that the foregoing disclosure is merely illustrative of various exemplary aspects of this application and that numerous modifications and variations can be readily made by skilled artisans which are within the spirit and scope of this application and the accompanying claims.

We claim:

1. A coating composition comprising:
an ionic liquid comprising a salt group and a first functional group;
a film-forming polymer comprising a second functional group; and
a curing agent comprising a third functional group;
wherein the first functional group is reactive towards at least one of the second functional group and the third functional group.

2. The coating composition of claim 1, wherein the salt group comprises pyridinium, pyrrolidinium, imidazolium, ammonium, guanidinium, phosphonium, isouronium, thiouronium or sulphonium.

3. The coating composition of claim 1, wherein the salt group comprises a halide, dicyanamide, tetrafluoroborate, hydrogen sulfate, methyl sulfate, octyl sulfate, hexafluorophosphate, bis(trifluoromethylsulfonyl)imide, tris(pentafluoroethyl)trifluorophosphate, trifluoromethanesulfonate, trifluoroacetate, thiocyanate, organoborate, and p-toluenesulfonate.

4. The coating composition of claim 1, wherein the ionic liquid comprises a salt group comprising imidazolium and chloride.

5. The coating composition of claim 1, wherein the ionic liquid comprises the structure according to formula (I):

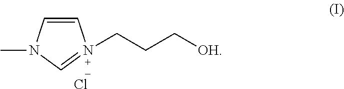

6. The coating composition of claim 1, wherein the ionic liquid comprises the structure according to formula (II): 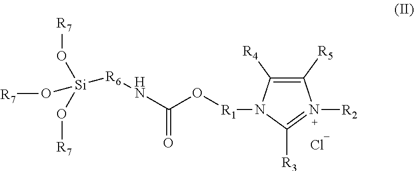
wherein R₁ is a substituted or unsubstituted C₁-C₃₆ alkanediyl group or a substituted or unsubstituted C₆-C₃₆ divalent aromatic group;
R₂ is hydrogen, a substituted or unsubstituted C₁-C₃₆ alkyl group or a substituted or unsubstituted C₆-C₃₆ aromatic group;
R₃ is hydrogen or a substituted or unsubstituted C₁-C₃₆ alkyl group;
R₄ is hydrogen or a substituted or unsubstituted C₁-C₃₆ alkyl group;
R₅ is hydrogen or a substituted or unsubstituted C₁-C₃₆ alkyl group;
R₆ is a substituted or unsubstituted C₁-C₃₆ alkanediyl group, a linear or branched C₃ to C₃₆ cycloaliphatic group, or a linear or branched C₆ to C₃₆ aromatic group; and
R₇ is a substituted or unsubstituted C₁-C₄ alkyl group.

7. The coating composition of claim 1, wherein the ionic liquid comprises the structure according to formula (III):

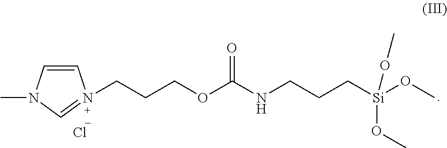

8. The coating composition of claim 1, wherein the ionic liquid comprises the structure according to formula (IV): 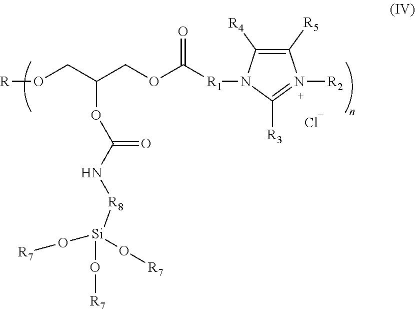
wherein n≥1;
R comprises a monovalent or polyvalent, substituted or unsubstituted C₁-C₃₆ alkane group, a monovalent or polyvalent C₆-C₃₆ aromatic group, a monovalent or polyvalent C₃-C₃₆ cycloaliphatic group, a monovalent or polyvalent polyester group having a number average molecular weight (Mₙ) of greater than 200 g/mol, a monovalent or polyvalent polyether group having a number average molecular weight (Mₙ) of greater than 200 g/mol, a monovalent or polyvalent acrylic resin having a number average molecular weight (Mₙ) of greater than 500 g/mol, or a monovalent or polyvalent polyurethane group having a number average molecular weight (Mₙ) of greater than 500 g/mol;
R₁ is a substituted or unsubstituted C₁-C₃₆ alkanediyl group or a substituted or unsubstituted C₆-C₃₆ divalent aromatic group;
R₂ is hydrogen, a substituted or unsubstituted C₁-C₃₆ alkyl group, or a substituted or unsubstituted C₆-C₃₆ aromatic group;
R₃ is hydrogen or a substituted or unsubstituted C₁-C₃₆ alkyl group;
R₄ is hydrogen or a substituted or unsubstituted C₁-C₃₆ alkyl group;
R₅ is hydrogen or a substituted or unsubstituted C₁-C₃₆ alkyl group;
R₆ is a C₁ to C₃₆ alkanediyl group, a linear or branched C₃ to C₃₆ cycloaliphatic group, or a linear or branched C₆ to C₃₆ aromatic group; and
R₇ is a substituted or unsubstituted C₁-C₄ alkyl group.

9. The coating composition of claim 1, wherein the ionic liquid is substantially free of alkali metals and alkaline earth metals.

10. The coating composition of claim 1, wherein the first functional group comprises a hydroxyl or an alkoxy silyl group.

11. The coating composition of claim 1, wherein the second functional group comprises a hydroxyl group, epoxy group, siloxane group, or combinations thereof.

12. The coating composition of claim 11, wherein the film-forming polymer includes at least two of the second functional group per molecule.

13. The coating composition of claim 1, wherein the third functional group comprises an isocyanato group, an amino group, or combinations thereof.

14. The coating composition of claim 13, wherein the curing agent comprises at least two of the third functional group per molecule.

15. The coating composition of claim 1 further comprising a silicone additive.

16. The coating composition of claim 1, wherein an at least partially cured coating formed from the coating composition of claim 1 comprising 5% ionic liquid by weight, based on the total weight of the resin solids, has an average maximum load reduced by at least 50% compared to an at least partially cured coating formed from a coating composition that does not include the ionic liquid, as measured according to Ice Adhesion Test.

17. The coating composition of claim 1, wherein an at least partially cured coating formed from the coating composition of claim 1 comprising 5% ionic liquid by weight, based on the total weight of the resin solids, has an average maximum stress reduced by at least 50% compared to an at least partially cured coating formed from a coating composition that does not include the ionic liquid, as measured according to Ice Adhesion Test.

18. A coating composition comprising:
an ionic liquid comprising a salt group and a first functional group; and
a self-curing film-forming polymer comprising a second functional group;
wherein the first functional group is reactive towards the second functional group.

19. A method of reducing ice adhesion to a substrate surface comprising applying the coating composition of claim 1 to the surface of the substrate and at least partially curing the coating composition to form a coating.

20. A substrate coated with the coating composition of claim 1 in an at least partially cured state.
